(19) United States
(12) Patent Application Publication
(10) Pub. No.: US 2008/0300744 A1
(43) Pub. Date: Dec. 4, 2008

(54) Connecting device, transmission, power output apparatus including the transmission, and method of controlling connecting device

(76) Inventors: Hiroshi Katsuta, Toyota-shi (JP); Hidehiro Oba, Aichi-gun (JP)

Correspondence Address: KENYON & KENYON LLP, 1500 K STREET N.W., SUITE 700, WASHINGTON, DC, 20005, US

(21) Appl. No.: 12/153,886

(22) Filed: May 27, 2008

(30) Foreign Application Priority Data
May 31, 2007 (JP) 2007-145929

(51) Int. Cl. B60W 20/00; F16H 59/74

(52) U.S. Cl. 701/22; 701/57; 701/1

(57) ABSTRACT

A motor MG1 is controlled so that the rotation speed deviation of the rotation speed of a first motor shaft 46 from the rotation speed of a second gear 62a matches a predetermined target rotation speed deviation and an actuator 92 is controlled so that a movable engaging member EM2 moves toward an engaging portion 62e for a predetermined time after the rotation speed has matched the target rotation speed deviation, if, for example, the movable engaging member EM2 is to be engaged with both of an engaging portion 46e and the engaging portion 62e of the second gear 62a to connect the first motor shaft 46 and the second gear 62a when the movable engaging member EM2 is engaged only with the engaging portion 46e of the first motor shaft 46.

### BACKGROUND OF THE INVENTION

1. Field of the Invention

The present invention relates to a connecting device capable of connecting two elements, a transmission, a power output apparatus including the transmission, and a method of controlling the connecting device.

2. Description of the Prior Art

Conventionally, a front-rear wheel drive vehicle has been known in which the front wheels are driven by an engine while the rear wheels are driven by a motor through a dog clutch (see, for example, Japanese Patent Laid-Open No. 2001-1779). In the front-rear wheel drive vehicle, once the rear wheels follow and the movable dog of the dog clutch rotates against the fixed dog upon the start of the vehicle using power from the engine, rotation of the movable dog is stopped by driving the motor at a predetermined target rotation speed corresponding to the wheel speed of the rear wheels to engage the movable dog to the fixed dog. In the front-rear wheel drive vehicle, the motor rotation speed is estimated from the current value and the duty value to the motor without using a motor rotation speed sensor, and a feedback control is applied to the motor so that the estimated motor rotation speed matches the target rotation speed.

### SUMMARY OF THE INVENTION

In the front-rear wheel drive vehicle, the motor is driven at a predetermined target rotation speed corresponding to the wheel speed of the rear wheels to halt the rotation of the movable dog to thereby engage the movable dog to the fixed dog. However, the movable dog and the fixed dog may not be able to smoothly engage if the dog teeth of the movable dog and the dog teeth of the fixed dog are not appropriately meshed when the rotation of the movable dog is stopped. To prevent such a situation, the rotation angles of two dogs to be connected may be detected to determine whether the dog teeth of two dogs are appropriately meshed with each other based on the detected rotation angles. However, in practice, it is not easy to determine whether the dog teeth of two dogs to be connected are appropriately meshed with each other.

A main object of the present invention is to easily and smoothly connect a first element and a second element in a connecting device including an engaging element mounted on each of the first and second elements and having a plurality of teeth and a movable engaging member having a plurality of teeth meshed with a plurality of teeth of both engaging elements.

A connecting device, a transmission, a power output apparatus including the transmission, and a method of controlling the connecting device of the present invention employs a following system in order to attain the main object.

The present invention is directed to a connecting device capable of connecting a first element and a second element rotated by a predetermined rotational drive source. The connecting device includes: a first engaging element mounted on the first element and having a plurality of teeth; a second engaging element mounted on the second element spaced apart from the first engaging element and having a plurality of teeth; a movable engaging element having a plurality of teeth that mesh with both of the plurality of teeth of the first engaging element and the plurality of teeth of the second engaging element and engageable to both of the first and second engaging elements; a drive unit capable of advancing and retracting the movable engaging element; and a control unit that controls the rotational drive source so that the deviation of the rotation speed of the second element from the rotation speed of the first element matches a predetermined target deviation if the movable engaging element is to be engaged with both of the first and second engaging elements to connect the first element and the second element when the movable engaging element is engaged with only one of the first and second engaging elements, and that controls the drive unit so that the movable engaging element moves toward the other of the first and second engaging elements for a predetermined time after the deviation has matched the target deviation.

The connecting device can engage the movable engaging element to only one of the first and second engaging elements to release the connection between the first element and the second element, and can engage the movable engaging element to both of the first and second engaging elements to connect the first element and the second element. In the connecting device, the rotation drive source is controlled so that the deviation of the rotation speed of the second element from the rotation speed of the first element matches the predetermined target deviation, and the drive unit is controlled so that the movable engaging element moves toward the other of the first and second engaging elements for the predetermined time after the deviation has matched the target deviation, if the movable engaging element is to be engaged to both of the first and second engaging elements to connect the first element and the second element when the movable engaging element is engaged to only one of the first and second engaging elements. The first and second engaging elements can be smoothly engaged, even when the plurality of teeth of the movable engaging member are unable to appropriately mesh with the plurality of teeth of the other of the first and second engaging elements, by moving the movable engaging element to the other of the first and second engaging elements when the deviation of the rotation speed of the second element from the rotation speed of the first element matches the predetermined target deviation and by pressing the movable engaging element against the other of the first and second engaging elements to cause the plurality of teeth of the movable engaging member to appropriately mesh with the plurality of teeth of the other of the first and second engaging elements. Controlling the drive unit for the predetermined time so that the movable engaging element moves toward the other of the first and second engaging elements enables to complete the connection of the first element and the second element without determining whether the movable engaging element has completely engaged with both of the first and second engaging elements. Therefore, the connecting device can easily and smoothly connect the first element and the second element with relatively simple control.

The target deviation may be a predetermined value other than a value 0. More specifically, if the movable engaging element is approximated to the other of the first and second engaging elements when a slight difference is formed in the rotational speeds of the first element and the second element with the target deviation being a relatively small value other than 0, the possibility of the plurality of teeth of the movable engaging member and the plurality of teeth of the other of the first and second engaging elements hitting each other when the movable engaging element abuts to the first and second engaging elements can be reduced. Forming a slight difference in the rotational speeds of the first element and the second element enables to promptly and appropriately mesh the plurality of teeth of the movable engaging member with the plurality of teeth of the other of the first and second engaging elements by pressing the movable engaging element against the other of the first and second engaging elements, even if the plurality of teeth of the movable engaging member and the plurality of teeth of the other of the first and second engaging elements hit each other when the movable engaging element abuts to the first and second engaging elements. Setting up the target deviation to a predetermined value other than 0 enables to press the movable engaging element against the other of the first and second engaging elements to thereby smoothly engage the first and second engaging elements. The target deviation may be a constant value other than 0, or may temporally (periodically) change as long as the value is not 0.

The control unit may also be designed to change the target deviation so that the sign of the deviation is inverted at least once after the deviation has matched the target deviation. Changing the target deviation so as to invert the sign of the deviation at least once after the deviation has matched the target deviation enables to make the rotation speeds of the first and second elements different again after temporarily matching the rotation speed of the first element and the rotation speed of the second element. Therefore, a situation can be prevented in which the movable engaging element is pressed against the other of the first and second engaging elements with excessive power being applied between the movable engaging member and the other of the first and second engaging elements, thereby enabling to smoothly connect the first element and the second element.

The control unit may also be designed to periodically change the target deviation at least after the deviation has matched the target deviation. This enables to suitably avoid the situation in which the movable engaging element is pressed against the other of the first and second engaging element with excessive power being applied between the movable engaging member and the other of the first and second engaging elements. This also enables to surely obtain a state in which the plurality of teeth of the movable engaging member and the plurality of teeth of the other of the first and second engaging elements are appropriately meshed with each other.

The control unit may also be designed to apply a feedback control to the rotational drive source so that the deviation matches the target deviation and inverts the sign of the target deviation when the deviation becomes substantially a value 0 after the deviation has temporarily matched the target deviation. Specifically, power may be outputted from the rotational drive source more than necessary due to the dispersion of the control variable or other reasons when applying a feedback control to the rotational drive source so that the deviation matches the target deviation which is a predetermined value other than 0. In that case, the power may be transmitted from the second element to the first element more than necessary, or smooth engagement of the first engaging element and the second engaging element may be hindered. Under the circumstances, inverting the sign of the target deviation when the value of the deviation becomes substantially 0 after the deviation has temporarily matched the target deviation enables to prevent the power from the rotational drive source to be outputted more than necessary due to the dispersion of the control variable or other reasons, prevent the transmission of excessive power from the second element to the first element, and realize the smooth engagement of the first engaging element and the second engaging element.

The control unit may also be designed to set the target deviation to a value 0 and changes the target deviation for a predetermined amount after the deviation has matched the target deviation. Setting the value of the target deviation to 0 and changing the target deviation for a predetermined amount after the deviation has matched the target deviation also enables to prevent the situation in which the movable engaging element is pressed against the other of the first and second engaging elements with excessive power being applied between the movable engaging member and the other of the first and second engaging elements, by appropriately meshing the plurality of teeth of the movable engaging member and the plurality of teeth of the other of the first and second engaging elements.

In this case, the predetermined amount may be a value based on the tooth thickness and the backlash of the second engaging element. This enables to surely obtain a state in which the plurality of teeth of the movable engaging member and the plurality of teeth of the other of the first and second engaging elements are appropriately meshed with each other.

The present invention is directed to a first transmission capable of selectively transmitting power from a first rotational drive source and power from a second rotational drive source to an output shaft. The transmission includes: a first input shaft connected to the first rotational drive source; a second input shaft connected to the second rotational drive source; an engaging element mounted on the first input shaft and having a plurality of teeth; an engaging element mounted on the second input shaft and having a plurality of teeth; a first transmission mechanism including at least a set of parallel shaft gear train including a driving gear rotatable about an axis extending in parallel with the output shaft and a driven gear meshed with the driving gear and connected to the output shaft; a second transmission mechanism including at least a set of parallel shaft gear train including a driving gear rotatable about an axis extending in parallel with the output shaft and a driven gear meshed with the driving gear and connected to the output shaft; an engaging element mounted on the driving gear of the first transmission mechanism and having a plurality of teeth; an engaging element mounted on the driving gear of the second transmission mechanism and having a plurality of teeth; a first movable engaging element having a plurality of teeth meshed with both of the plurality of teeth of the engaging element mounted on the first input shaft and the plurality of teeth of the engaging element mounted on the driving gear of the first transmission mechanism and engageable to both engaging elements; a first drive unit capable of advancing and retracting the first movable engaging element; a second movable engaging element having a plurality of teeth meshed with both of the plurality of teeth of the engaging element mounted on the second input shaft and the plurality of teeth of the engaging element mounted on the driving gear of the second transmission mechanism and engageable to both engaging elements; a second drive unit capable of advancing and retracting the second movable engaging element; and a control unit that controls the first or second rotational drive source so that the deviation of the rotation speed of the first or second input shaft from the rotation speed of the driving gear of the first or second transmission mechanism matches a predetermined target deviation if the first or second movable engaging element is to be engaged with both of the two engaging elements corresponding to the first or second movable engaging element when the first or second movable engaging element is engaged with only one of the two engaging elements corresponding to the first or second movable engaging element, and that controls the first or second drive unit so that the first or second movable engaging element moves toward the other of the engaging elements corresponding to the first or second movable engaging element for a predetermined time after the deviation has matched the target deviation.

In the transmission, the control of the first and second drive units enables to easily and smoothly switch between the transmission state in which power from the first rotational drive source is shifted by the first transmission mechanism and transmitted to the output shaft and the transmission state in which power from the second rotational drive source is shifted by the second transmission mechanism and transmitted to the output shaft. Therefore, the transmission allows selective and efficient transmission of power from the first rotational drive source and power from the second rotational drive source to the output shaft.

The present invention is directed to a second transmission capable of selectively transmitting power from a first rotational drive source and power from a second rotational drive source to an output shaft. The transmission includes: a first input shaft connected to the first rotational drive source; a second input shaft connected to the second rotational drive source; a first transmission planetary gear mechanism including an input element connected to the first input shaft, an output element connected to the output shaft, and a fixable element; a second transmission planetary gear mechanism including an input element connected to the second input shaft, an output element connected to the output shaft, and a fixable element; an engaging element mounted on the fixable element of the first transmission planetary gear mechanism and having a plurality of teeth; a nonrotatable fixed engaging element disposed with respect to the first transmission planetary gear mechanism and having a plurality of teeth; an engaging element mounted on the fixable element of the second transmission planetary gear mechanism and having a plurality of teeth; a nonrotatable fixed engaging element disposed with respect to the second transmission planetary gear mechanism and having a plurality of teeth; a first movable engaging element having a plurality of teeth meshed with both of the plurality of teeth of the engaging element mounted on the fixable element of the first transmission planetary gear mechanism and the plurality of teeth of the fixed engaging element disposed with respect to the first transmission planetary gear mechanism and engageable to both of the engaging element and the fixed engaging element; a first drive unit capable of advancing and retracting the first movable engaging element; a second movable engaging element having a plurality of teeth meshed with both of the plurality of teeth of the engaging element mounted on the fixable element of the second transmission planetary gear mechanism and the plurality of teeth of the fixed engaging element disposed with respect to the second transmission planetary gear mechanism and engageable to both of the engaging element and the fixed engaging element; a second drive unit capable of advancing and retracting the second movable engaging element; a control unit that controls the first or second rotational drive source so that the deviation of the rotation speed of the fixable element included in the first or second transmission planetary gear mechanism from a value 0 matches a predetermined target deviation if the first or second movable engaging element is to be engaged with both of the engaging element and the fixed engaging element corresponding to the first or second movable engaging element when the first or second movable engaging element is engaged with only one of the engaging element and the fixed engaging element corresponding to the first or second movable engaging element, and that controls the first or second drive unit so that the first or second movable engaging element moves toward the other of the engaging element and the fixed engaging element corresponding to the first or second movable engaging element for a predetermined time after the deviation has matched the target deviation.

In the transmission, the control of the first and second drive units enables to easily and smoothly switch between the transmission state in which power from the first rotational drive source is shifted by the first transmission planetary gear mechanism and transmitted to the output shaft and the transmission state in which power from the second rotational drive source is shifted by the second transmission planetary gear mechanism and transmitted to the output shaft. Therefore, the transmission allows selective and efficient transmission of power from the first rotational drive source and power from the second rotational drive source to the output shaft.

The second transmission may also be designed to further include an engaging element mounted on an output element of one of the first and second transmission planetary gear mechanisms and having a plurality of teeth, wherein the first or second movable engaging element corresponding to one of the first and second transmission planetary gear mechanisms is engageable to both of the fixable element of one of the first and second transmission planetary gear mechanisms and the engaging element mounted on the output element, and wherein the control unit controls the first or second rotational drive source so that the deviation of the rotation speed of the fixable element from the rotation speed of the output element matches a predetermined target deviation if the first or second movable engaging element is to be engaged with the engaging elements of both of the fixable element and the output element corresponding to the first or second movable engaging element when the first or second movable engaging element corresponding to one of the first and second transmission planetary gear mechanisms is engaged with the engaging element of only one of the fixable element and the output element corresponding to one of the first and second transmission planetary gear mechanisms, and that controls the first or second drive unit so that the first or second movable engaging element moves toward the engaging portion of the other of the fixable element and the output element corresponding to the first or second movable engaging element for a predetermined time after the deviation has matched the target deviation. The transmission enables to easily and smoothly realize transmission of power from the first or second rotational drive source to the output shaft at a transmission gear ratio 1.

The present invention is directed to a first power output apparatus that outputs power to a drive shaft. The power output apparatus includes: an internal combustion engine; a first motor capable of inputting and outputting power; a second motor capable of inputting and outputting power; an accumulator unit capable of inputting and outputting electric power from and to the first and second motors; a power distribution and integration mechanism having a first rotating element connected to the rotating shaft of the first motor, a second rotating element connected to the rotating shaft of the second motor, and the third rotating element connected to the engine shaft of the internal combustion engine, the three rotating elements configured to be able to differentially rotate; a first input shaft connected to the first rotating element of the power distribution and integration mechanism; a second input shaft connected to the second rotating element of the power distribution and integration mechanism; an engaging element mounted on the first input shaft and having a plurality of teeth; an engaging element mounted on the second input shaft and having a plurality of teeth; a first transmission mechanism including at least a set of parallel shaft gear train including a driving gear rotatable about an axis extending in parallel with the output shaft and a driven gear meshed with the driving gear and connected to the output shaft; a second transmission mechanism including at least a set of parallel shaft gear train including a driving gear rotatable about an axis extending in parallel with the output shaft and a driven gear meshed with the driving gear and connected to the output shaft; an engaging element mounted on the driving gear of the first transmission mechanism and having a plurality of teeth; an engaging element mounted on the driving gear of the second transmission mechanism and having a plurality of teeth; a first movable engaging element having a plurality of teeth meshed with both of the plurality of teeth of the engaging element mounted on the first input shaft and the plurality of teeth of the engaging element mounted on the driving gear of the first transmission mechanism and engageable to both engaging elements; a first drive unit capable of advancing and retracting the first movable engaging element; a second movable engaging element having a plurality of teeth meshed with both of the plurality of teeth of the engaging element mounted on the second input shaft and the plurality of teeth of the engaging element mounted on the driving gear of the second transmission mechanism and engageable to both engaging elements; a second drive unit capable of advancing and retracting the second movable engaging element; and a control unit that controls the first or second rotational drive source so that the deviation of the rotation speed of the first or second input shaft from the rotation speed of the driving gear of the first or second transmission mechanism matches a predetermined target deviation if the first or second movable engaging element is to be engaged with both of the two engaging elements corresponding to the first or second movable engaging element when the first or second movable engaging element is engaged with only one of the two engaging elements corresponding to the first or second movable engaging element, and that controls the first or second drive unit so that the first or second movable engaging element moves toward the other of the engaging elements corresponding to the first or second movable engaging element for a predetermined time after the deviation has matched the target deviation.

The power output apparatus allows selective and efficient transmission of power from the first and second rotating elements of the power distribution and integration mechanism to the output shaft. Therefore, the power output apparatus enables to suitably improve the transmission efficiency of power in a wider operating range.

The present invention is directed to a second power output apparatus that outputs power to a drive shaft. The power output apparatus includes: an internal combustion engine; a first motor capable of inputting and outputting power; a second motor capable of inputting and outputting power; an accumulator unit capable of inputting and outputting electric power from and to the first and second motors; a power distribution and integration mechanism having a first rotating element connected to the rotating shaft of the first motor, a second rotating element connected to the rotating shaft of the second motor, and the third rotating element connected to the engine shaft of the internal combustion engine, the three rotating elements configured to be able to differentially rotate; a first input shaft connected to the first rotating element of the power distribution and integration mechanism; a second input shaft connected to the second rotating element of the power distribution and integration mechanism; a first input shaft connected to the first rotational drive source; a second input shaft connected to the second rotational drive source; a first transmission planetary gear mechanism including an input element connected to the first input shaft, an output element connected to the output shaft, and a fixable element; a second transmission planetary gear mechanism including an input element connected to the second input shaft, an output element connected to the output shaft, and a fixable element; an engaging element mounted on the fixable element of the first transmission planetary gear mechanism and having a plurality of teeth; a nonrotatable fixed engaging element disposed with respect to the first transmission planetary gear mechanism and having a plurality of teeth; an engaging element mounted on the fixable element of the second transmission planetary gear mechanism and having a plurality of teeth; a nonrotatable fixed engaging element disposed with respect to the second transmission planetary gear mechanism and having a plurality of teeth; a first movable engaging element having a plurality of teeth meshed with both of the plurality of teeth of the engaging element mounted on the fixable element of the first transmission planetary gear mechanism and the plurality of teeth of the fixed engaging element disposed with respect to the first transmission planetary gear mechanism and engageable to both of the engaging element and the fixed engaging element; a first drive unit capable of advancing and retracting the first movable engaging element; a second movable engaging element having a plurality of teeth meshed with both of the plurality of teeth of the engaging element mounted on the fixable element of the second transmission planetary gear mechanism and the plurality of teeth of the fixed engaging element disposed with respect to the second transmission planetary gear mechanism and engageable to both of the engaging element and the fixed engaging element; a second drive unit-capable of advancing and retracting the second movable engaging element; a control unit that controls the first or second rotational drive source so that the deviation of the rotation speed of the fixable element included in the first or second transmission planetary gear mechanism from a value 0 matches a predetermined target deviation if the first or second movable engaging element is to be engaged with both of the engaging element and the fixed engaging element corresponding to the first or second movable engaging element when the first or second movable engaging element is engaged with only one of the engaging element and the fixed engaging element corresponding to the first or second movable engaging element, and that controls the first or second drive unit so that the first or second movable engaging element moves toward the other of the engaging element and the fixed engaging element corresponding to the first or second movable engaging element for a predetermined time after the deviation has matched the target deviation.

The present invention is directed to a method of controlling a connecting device that can connect a first element and a second element rotated by a predetermined rotational drive source. The connecting device includes: a first engaging element mounted on the first element and having a plurality of teeth, a second engaging element mounted on the second element and having a plurality of teeth; a movable engaging element having a plurality of teeth meshed with both of the plurality of teeth of the first engaging element and the plurality of teeth of the second engaging element and engageable to both of the first and second engaging elements; and a drive unit capable of advancing and retracting the movable engaging element. The method of controlling the connecting device includes: (a) a step of controlling the rotational drive source so that the deviation of the rotation speed of the second element from the rotation speed of the first element matches a predetermined target deviation if the movable engaging element is to be engaged with both of the first and second engaging elements to connect the first element and the second element when the movable engaging element is engaged with only one of the first and second engaging elements; and (b) a step of controlling the drive unit so that the movable engaging element moves toward the other of the first and second engaging element for a predetermined time after the deviation has matched the target deviation.

The first and second engaging elements can be smoothly engaged, even when the plurality of teeth of the movable engaging member are unable to appropriately mesh with the plurality of teeth of the other of the first and second engaging elements, by moving the movable engaging element to the other of the first and second engaging elements when the deviation of the rotation speed of the second element from the rotation speed of the first element matches the predetermined target deviation and by pressing the movable engaging element against the other of the first and second engaging elements to cause the plurality of teeth of the movable engaging member to appropriately mesh with the plurality of teeth of the other of the first and second engaging elements. Controlling the drive unit for the predetermined time so that the movable engaging element moves toward the other of the first and second engaging elements enables to complete the connection of the first element and the second element without determining whether the movable engaging element has completely engaged with both of the first and second engaging elements. Therefore, the method of controlling the connecting device can easily and smoothly connect the first element and the second element with relatively simple control.

In this case, the target deviation may be a predetermined value other than a value 0.

The step (b) may change the target deviation so that the sign of the deviation is inverted at least once after the deviation has matched the target deviation.

The step (b) may periodically change the target deviation at least after the deviation has matched the target deviation.

The step (a) may apply a feedback control to the rotational drive source so that the deviation matches the target deviation, and the step (b) may invert the sign of the target deviation when the deviation becomes substantially a value 0 after the deviation has temporarily matched the target deviation.

The target deviation may be a value 0 in the step (a), and the step (b) may change the target deviation for a predetermined amount after the deviation has matched the target deviation.

The predetermined amount may be a value based on the tooth thickness and the backlash of the second engaging element.

### BRIEF DESCRIPTION OF THE DRAWINGS

FIG. 1 is a schematic configuration diagram of a hybrid vehicle 20 according to an embodiment of the present invention;

FIG. 2 is a cross sectional view of an engaging portion 45e of a carrier shaft 45a constituting a clutch C1 of a transmission 60 and a movable engaging member EM1;

FIG. 3 is an explanatory view of a tapered portion TP formed on the dog teeth of the movable engaging member EM1 and the dog teeth of an engaging portion 61e;

FIG. 4 is an explanatory view illustrating the relationship between the rotation speeds and torque of main elements of a power distribution and integration mechanism 40 and the transmission 60 when the transmission state of the transmission 60 is changed upon running of the hybrid vehicle 20 involving engagement of a clutch C0 and operation of an engine 22;

FIG. 5 is an explanatory view similar to FIG. 4;

FIG. 6 is an explanatory view similar to FIG. 4;

FIG. 7 is an explanatory view similar to FIG. 4;

FIG. 8 is an explanatory view similar to FIG. 4;

FIG. 9 is an explanatory view similar to FIG. 4;

FIG. 10 is an explanatory view similar to FIG. 4;

FIG. 11 is an explanatory view of an example of an alignment chart showing the relationship between the rotation speeds and torque of elements of the power distribution and integration mechanism 40 when a motor MG1 functions as a generator and a motor MG2 functions as an electric motor;

FIG. 12 is an explanatory view of an example of an alignment chart showing the relationship between the rotation speeds and torque of elements of the power distribution and integration mechanism 40 when the motor MG2 functions as a generator and the motor MG1 functions as an electric motor;

FIG. 13 is an explanatory view for describing a motor running mode in the hybrid vehicle 20;

FIG. 14 is a flow chart of an example of a drive and control routine executed by a hybrid ECU 70 upon running of the hybrid vehicle 20 involving engagement of the clutch C0 and operation of the engine 22;

FIG. 15 is a flow chart of an example of a drive and control routine executed by the hybrid ECU 70 upon running of the hybrid vehicle 20 involving engagement of the clutch C0 and operation of the engine 22;

FIG. 16 is an explanatory view of an example of a torque demand setting map;

FIG. 17 is an explanatory view illustrating a correlation curve (equal power line) of an operation line of the engine 22, an engine rotation speed Ne, and an engine torque Te;

FIG. 18 is an explanatory view of a setting mode of a target rotation speed deviation Nerr*;

FIG. 19 is an explanatory view of a setting mode of a target rotation speed deviation Nerr*;

FIG. 20 is a flow chart of another example of the drive and control routine;

FIG. 21 is a flow chart of still another example of the drive and control routine;

FIG. 22 is a schematic configuration diagram of a hybrid vehicle 20A according to a modified example;

FIG. 23 is a schematic configuration diagram of another transmission 100 applicable to the hybrid vehicle 20 and the like;

FIG. 24 is an explanatory view of operation states of brake clutches BC1, BC2, a brake B3, and the clutch C0 of the transmission 100;

FIG. 25 is a schematic configuration diagram of another transmission 200 applicable to the hybrid vehicle 20 and the like;

FIG. 26 is an explanatory view of operation states of clutches C11, C12, and C0 of the transmission 200; and

FIG. 27 is a schematic configuration diagram of a hybrid vehicle 20B according to a modified example.

### DESCRIPTION OF THE PREFERRED EMBODIMENT

The best mode for implementing the present invention will now be described using the embodiments.

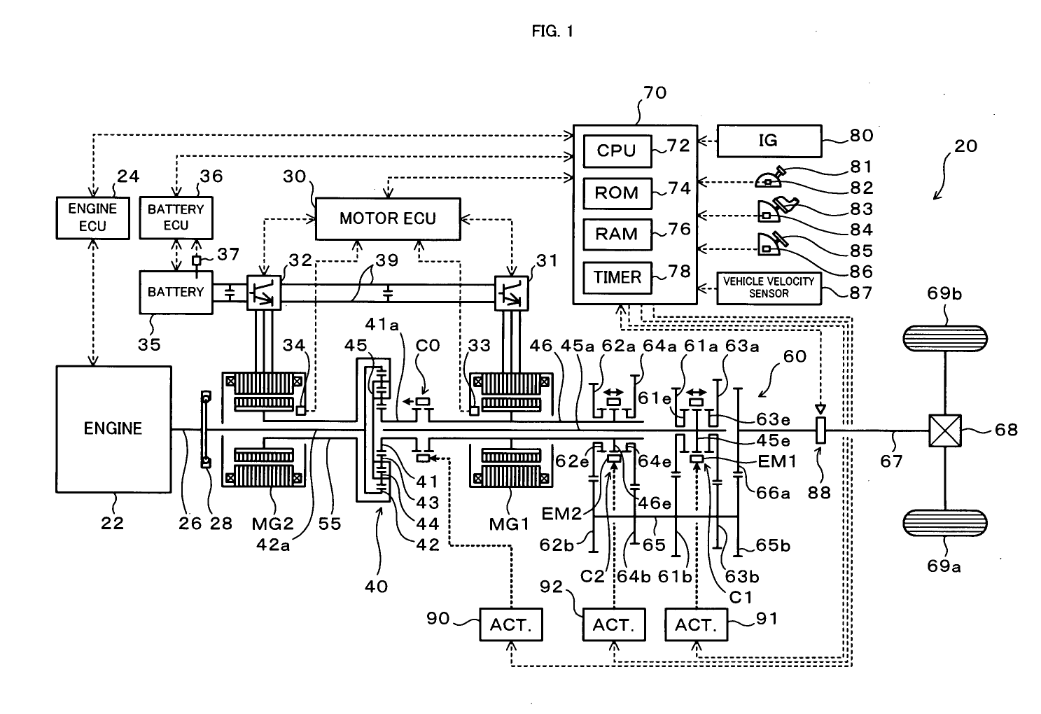

FIG. 1 is a schematic configuration diagram of a hybrid vehicle 20 provided with a transmission including a connecting device according to an embodiment of the present invention. The hybrid vehicle 20 shown in FIG. 1 is configured as a rear wheel drive vehicle and includes, for example: an engine 22 mounted on the vehicle front part; a power distribution and integration mechanism (differential rotation mechanism) 40 connected to a crankshaft (engine shaft) 26 of the engine 22; a motor MG1 connected to the power distribution and integration mechanism 40 and capable of generating electricity; a motor MG 2 arranged coaxially with the motor MG 1, connected to the power distribution and integration mechanism 40, and capable of generating electricity; a transmission 60 capable of shifting power from the power distribution and integration mechanism 40 and transmitting the power to a drive shaft 67; and a hybrid electronic control unit (hereinafter, “hybrid ECU”) 70 that controls the entire hybrid vehicle 20.

The engine 22 is an internal combustion engine supplied with hydrocarbon fuel such as gasoline and light oil to output power, and an engine electronic control unit (hereinafter, “engine ECU”) 24 controls the amount of fuel injection, ignition timing, intake air flow, and the like of the engine 22. Signals are inputted to the engine ECU 24, the signals of which are from various sensors, such as a crank position sensor (not shown) attached to the crankshaft 26, that are disposed with respect to the engine 22 and that detects the operational status of the engine. The engine ECU 24 communicates with the hybrid ECU 70 and controls the operation of the engine 22 based on control signals from the hybrid ECU 70 or signals from the sensors, and further outputs data related to the operation status of the engine 22 to the hybrid ECU 70 as necessary.

Both of the motor MG1 and the motor MG2 are synchronous motor generators that are driven as a generator and as a motor, and having the same specifications. The motor MG1 and the motor MG2 exchange electric power with a battery 35, which is a secondary battery, through inverters 31 and 32. A power line 39 that connects the inverters 31, 32, and the battery 35 is constituted as a positive electrode bus line and a negative electrode bus line shared by the inverters 31 and 32, and one of the motors MG1 and MG2 can consume electric power generated by the other motor. Therefore, the battery 35 is charged and discharged in accordance with the electric power generated from one of the motors MG1 and MG2 and insufficient electric power, and the electric power is not charged or discharged if the motors MG1 and MG2 are designed to balance the power. A motor electronic control unit (hereinafter, “motor ECU”) 30 drives and controls the motors MG1 and MG2. Signals required for driving and controlling the motors MG1 and MG2, such as signals from rotational position detection sensors 33 and 34 that detect rotational positions of the rotors of the motors MG1 and MG2, or phase currents detected by a current sensor (not shown) and applied to the motors MG1 and MG2 are inputted to the motor ECU 30, and the motor ECU 30 outputs switching control signals or the like to the inverters 31 and 32. The motor ECU 30 executes a rotation speed calculation routine (not shown) based on signals inputted from the rotational position detection sensors 33 and 34 to calculate rotation speeds Nm1 and Nm2 of the rotors of the motors MG1 and MG2. The motor ECU 30 further communicates with the hybrid ECU 70, drives and controls the motors MG1 and MG2 based on control signals or the like from the hybrid ECU 70, and outputs data related to the operation status of the motors MG1 and MG2 to the hybrid ECU 70 as necessary.

A battery electronic control unit (hereinafter, “battery ECU”) 36 manages the battery 35. Signals necessary for managing the battery 35, such as an inter-terminal voltage from a voltage sensor (not shown) arranged between the terminals of the battery 35, a charge-discharge current from a current sensor (not shown) attached to a power line 39 connected to the output terminal of the battery 35, and a battery temperature Tb from a temperature sensor 37 attached to the battery 35 are inputted to the battery ECU 36. The battery ECU 36 outputs data related to the state of the battery 35 to the hybrid ECU 70 or the engine ECU 24 through communication as necessary. To manage the battery 35, the battery ECU 36 of the embodiment calculates a state of charge SOC based on an integrated value of the charge-discharge current detected by the current sensor, calculates charge-discharge power demand Pb* of the battery 35 based on the state of charge SOC, or calculates an input limit Win as allowable charge power that is electric power allowed to charge the battery 35 and an output limit Wout as allowable discharge power that is electric power allowed to discharge the battery 35 based on the state of charge SOC and the battery temperature Tb. The input limit Win and the output limit Wout of the battery 35 can be established by setting up basic values of the input limit Win and the output limit Wout based on the battery temperature Tb, setting up output-limit correction factors and input-limit correction factors based on the state of charge (SOC) of the battery 35, and multiplying the set basic values of the input limit Win and the output limit Wout by the correction factors.

The power distribution and integration mechanism 40 is accommodated in a transmission case (not shown) along with the motors MG1, MG2, and the transmission 60 and arranged coaxially with the crankshaft 26 a predetermined distance apart from the engine 22. The power distribution and integration mechanism 40 of the embodiment is a double-pinion planetary gear mechanism having a sun gear 41 of the external gear, a ring gear 42 of the internal gear disposed concentrically with the sun gear 41, and a carrier 45 holding at least a set of two rotatable and revolvable pinion gears 43 and 44 that are meshed with each other and in which one is meshed with the sun gear 41 and the other is meshed with the ring gear 42. The sun gear 41 (second rotating element), the ring gear 42 (third rotating element), and the carrier 45 (first rotating element) can differentially rotate. In the embodiment, the power distribution and integration mechanism 40 is configured such that the gear ratio p (the number of teeth of the sun gear 41 divided by the number of teeth of the ring gear 42) is ρ=0.5. In this way, the distribution ratios of torque from the engine 22 are the same between the sun gear 41 and the carrier 45, thereby making the specifications of the motors MG1 and MG2 the same without using a reduction gear mechanism or the like and achieving miniaturization of the power output apparatus, improvement in productivity, and cost reduction. However, the gear ratio ρ of the power distribution and integration mechanism 40 can be selected from a range of about 0.4 to 0.6, for example. The motor MG1 (hollow rotor) as a second motor is connected to the sun gear 41, which is a second rotating element of the power distribution and integration mechanism 40, through a hollow sun gear shaft 41a and a hollow first motor shaft 46 extending from the sun gear 41 to the opposite side of the engine 22 (back of the vehicle). The motor MG2 (hollow rotor) as a first motor is connected to the carrier 45, which is a first rotating element, through a hollow second motor shaft 55 extending toward the engine 22. Furthermore, the crankshaft 26 of the engine 22 is connected to the ring gear 42, which is a third rotating element, through a ring gear shaft 42a and a dumper 28 extending through the second motor shaft 55 and the motor MG2.

As shown in FIG. 1, a clutch C0 (connection disconnection unit) for connecting (drive source element connection) and releasing the connection of the sun gear shaft 41a and the first motor shaft 46 is mounted therebetween. In the embodiment, the clutch C0 is, for example, engageable to both of an engaging portion fixed to the sun gear shaft 41a and an engaging portion fixed to the first motor shaft 46, and is configured as a dog clutch including a movable engaging member advanced and retracted by an electromagnetic, electric, or hydraulic actuator 90 in the axial direction of the sun gear shaft 41a, the first motor shaft 46, and the like. When the clutch C0 releases the connection of the sun gear shaft 41a and the first motor shaft 46, the connection of the motor MG1 as a second motor and the sun gear 41 of the power distribution and integration mechanism 40 is released, thereby allowing a function of the power distribution and integration mechanism 40 to substantially separate the engine 22 from the motors MG1, MG2, or the transmission 60. The first motor shaft 46, which can be connected to the sun gear 41 of the power distribution and integration mechanism 40 through the clutch C0, further extends from the motor MG1 to the opposite side of the engine 22 (back of the vehicle) and is connected to the transmission 60. From the carrier 45 of the power distribution and integration mechanism 40, a carrier shaft (connecting shaft) 45a extends to the opposite side of the engine 22 (back of the vehicle) through the hollow sun gear shaft 41a or the first motor shaft 46. The carrier shaft 45a is also connected to the transmission 60. Thus, in the embodiment, the power distribution and integration mechanism 40 is arranged coaxially with the motors MG1 and MG2 between the motors MG1 and MG2 arranged coaxially. The engine 22 is arranged coaxially side by side with the motor MG2 and opposes the transmission 60 across the power distribution and integration mechanism 40. Therefore, in the embodiment, components of the power output apparatus including the engine 22, the motors MG1, MG2, the power distribution and integration mechanism 40, and the transmission 60 are arranged in the order of, from the front of the vehicle, the engine 22, the motor MG2, the power distribution and integration mechanism 40, the motor MG1, and the transmission 60. This enables to provide a power output apparatus suitable for the hybrid vehicle 20 compact in size, excellent in mountability, and driven mainly by the rear wheels.

The transmission 60 is configured as a parallel shaft automatic transmission capable of setting the transmission state (transmission gear ratio) in a plurality of stages and includes a first counter drive gear 61a and a first counter driven gear 61b constituting a first-speed gear train, a second counter drive gear 62a and a second counter driven gear 62b constituting a second-speed gear train, a third counter drive gear 63a and a third counter driven gear 63b constituting a third-speed gear train, a fourth counter drive gear 64a and a fourth counter driven gear 64b constituting a fourth-speed gear train, a counter shaft 65 to which the counter driven gears 61b to 64b and a gear 65b are fixed, clutches C1 and C2 as connecting devices of the present invention, and a gear 66a attached to the drive shaft 67, and further includes a reverse gear train (not shown) and so forth (hereinafter, “first- to fourth-speed gear trains” may be simply called “gear trains”, and “counter drive gears” and “counter driven gears” may be simply called “gears”). In the transmission 60 of the embodiment, the gear ratio (transmission gear ratio) of the first-speed gear train G(1) is the greatest, and the gear ratio G(n) becomes smaller as the gear train is shifted to the second-speed gear train, the third-speed gear train, and the fourth-speed gear train.

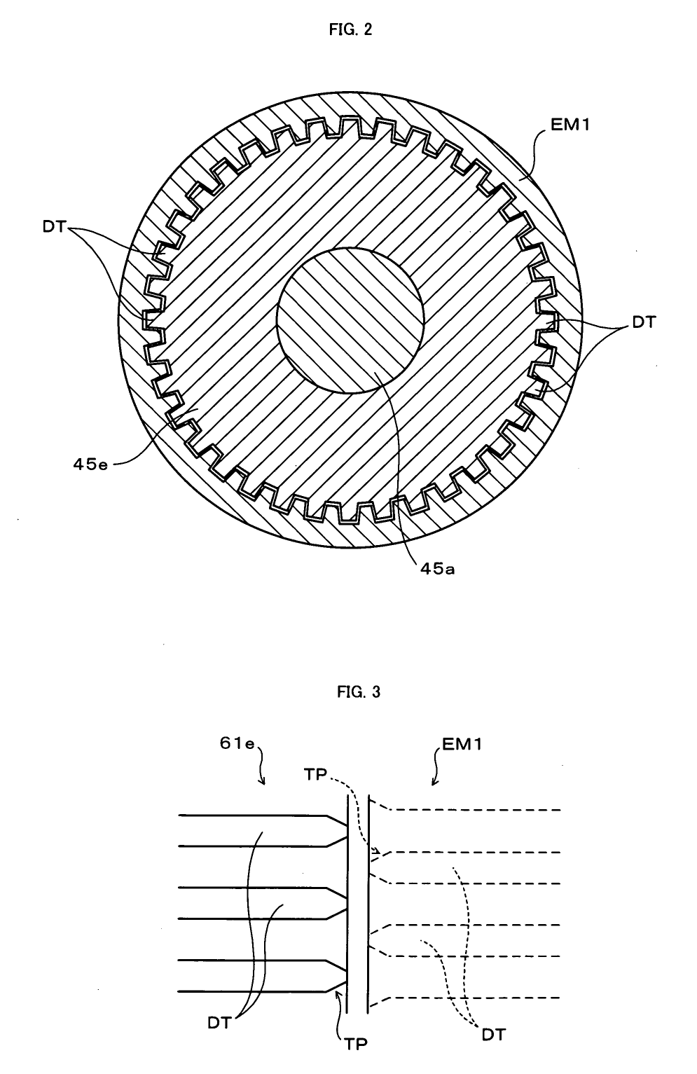

As shown in FIG. 1, the carrier shaft 45a extending from the carrier 45 of the power distribution and integration mechanism 40 holds the first gear 61a of the first-speed gear train rotatably and unmovably in the axial direction, and the first gear 61a is constantly meshed with the first gear 61b fixed to the counter shaft 65. Similarly, the carrier shaft 45a holds the third gear 63a of the third-speed gear train rotatably and unmovably in the axial direction, and the third gear 63a is constantly meshed with the third gear 63b fixed to the counter shaft 65. In the embodiment, a clutch C1 is arranged on the carrier shaft 45a side (counter drive gear side), the clutch C1 capable of selectively fixing one of the first gear 61a (first-speed gear train) and the third gear 63a (third-speed gear train) to the carrier shaft 45a and capable of making both of the first gear 61a and the third gear 63a rotatable (releasable) to the carrier shaft 45a. In the embodiment, the clutch C1 is configured as a dog clutch including a movable engaging member EM1 capable of being advanced and retracted in the axial direction of the carrier shaft 45a and the like by an electromagnetic, electric, or hydraulic actuator 91 so as to connect an engaging portion 45e (second engaging portion) fixed to the carrier shaft 45a as a second element rotatable around the shaft extending coaxially with the rotating shaft of the first gear 61a or the third gear 63a as a first element by the motor MG2 or the like to one of an engaging portion 61e (first engaging portion) fixed to the first gear 61a and an engaging portion 63e (first engaging portion) fixed to the third gear 63a. As shown in FIG. 2, the engaging portion 45e of the carrier shaft 45a is configured as an external gear-shaped dog having a plurality of (for example, 36) dog teeth DT. The engaging portion 61e of the first gear 61a and the engaging portion 63e of the third gear 63a are also configured as an external gear-shaped dog having a plurality of dog teeth DT, the dog teeth DT being the same number and the same module as the dog teeth of the engaging portion 45e of the carrier shaft 45a. In the embodiment, the engaging portion 45e of the carrier shaft 45a is fixed to the carrier shaft 45a, between the engaging portion 61e of the first gear 61a and the engaging portion 63e of the third gear 63a, with predetermined spaces apart from the engaging portions. As shown in FIG. 2, the movable engaging member EM1 is configured as an internal gear-shaped dog having a plurality of dog teeth DT, the dog teeth DT being the same number and the same module as the dog teeth of the engaging portion 45e of the carrier shaft 45a, the engaging portion 61e of the first gear 61a, and the engaging portion 63e of the third gear 63a. The movable engaging member EM1 has such a dimension that allows simultaneous engagement with the engaging portion 45e of the carrier shaft 45a and one of the engaging portions 61e and 63e of the first gear 61a and the third gear 63. In the embodiment, the movable engaging member EM1 in a predetermined neutral position is only engaged (constantly meshed) to the engaging portion 45e of the carrier shaft 45a, and the actuator 91 advances and retracts the movable engaging member EM1 in the axial direction of the carrier shaft 45a, the first gear 61a, and the third gear 63a. As a result, the actuator 91 moves the movable engaging member EM1 and causes the movable engaging member EM1 to engage with both of the engaging portion 45e of the carrier shaft 45a and the engaging portion 61e of the first gear 61a, thereby allowing the connection of the carrier shaft 45a and the first gear 61a. The actuator 91 moves the movable engaging member EM1 and causes the movable engaging member EM1 to engage with both of the engaging portion 45e of the carrier shaft 45a and the engaging portion 63e of the third gear 63a, thereby allowing the connection of the carrier shaft 45a and the third gear 63a. A tapered portion TP as shown in FIG. 3 is formed at the edge in the tooth width direction of each dog tooth DT of the engaging portions 45e, 61e, 63e, and the movable engaging member EM1 so that easy, reliable, and appropriate meshing of the plurality of dog teeth DT of the movable engaging member EM1 and the dog teeth DT of the engaging portions 45e, 61e, and 63e is possible by pressing the movable engaging member EM1 against the engaging portions 45e, 61e, or 63e even when the plurality of dog teeth DT of the movable engaging member EM1 and the dog teeth DT of the engaging portions 45e, 61e, and 63e are unable to be meshed appropriately. The gears 61a and 61b of the first-speed gear trains, the gears 63a and 63b of the third-speed gear train, and the clutch C1 constitute a first transmission mechanism of the transmission 60.

The first motor shaft 46, which can be connected to the sun gear 41 of the power distribution and integration mechanism 40 through the clutch C0, holds the second gear 62a of the second-speed gear train rotatably and unmovably in the axial direction, and the second gear 62a is constantly meshed with the second gear 62b fixed to the counter shaft 65. Similarly, the first motor shaft 46 holds the fourth gear 64a of the fourth-speed gear train rotatably and unmovably in the axial direction, and the fourth gear 64a is constantly meshed with the fourth gear 64b fixed to the counter shaft 65. In the embodiment, one of the second gear 62a (second-speed gear train) and the fourth gear 64a (fourth-speed gear train) is selectively fixed to the first motor shaft 46 on the first motor shaft 46 side (counter drive gear side), and a clutch C2 capable of making both of the second gear 62a and the fourth gear 64a rotatable (releasable) relative to the first motor shaft 46 is also installed. In the embodiment, the clutch C2 is configured as a dog clutch including a movable engaging member EM2 capable of being advanced and retracted in the axial direction of the first motor shaft 46 and the like by an electromagnetic, electric, or hydraulic actuator 92 so as to connect an engaging portion 46e (second engaging portion) fixed to the first motor shaft 46 as a second element rotatable around the shaft extending coaxially with the rotating shaft of the second gear 62a or the fourth gear 64a as a first element by the motor MG1 or the like to one of an engaging portion 62e (first engaging portion) fixed to the second gear 62a and an engaging portion 64e (first engaging portion) fixed to the fourth gear 64a. The engaging portion 46e of the first motor shaft 46 is configured as an external gear-shaped dog having a plurality (for example, 36) of dog teeth DT. The engaging portion 62e of the second gear 62a and the engaging portion 64e of the fourth gear 64a are also configured as external gear-shaped dogs having a plurality of dog teeth DT, the dog teeth being the same number and the same module as the dog teeth of the engaging portion 46e of the first motor shaft 46. In the embodiment, the engaging portion 46e of the first motor shaft 46 is fixed to the first motor shaft 46 between the engaging portion 62e of the second gear 62a and the engaging portion 64e of the fourth gear 64a, predetermined spaces apart from the engaging portions. The movable engaging member EM2 is configured as an internal gear-shaped dog having a plurality of dog teeth DT, the dog teeth DT being the same number and the same module as the dog teeth of the engaging portion 46e of the first motor shaft 46, the engaging portion 62e of the second gear 62a, and the engaging portion 64e of the fourth gear 64a. The movable engaging member EM2 has such a dimension that allows simultaneous engagement with the engaging portion 46e of the first motor shaft 46 and one of the engaging portions 62e and 64e of the second gear 62a and the fourth gear 64a. In the embodiment, the movable engaging member EM2 in a predetermined neutral position is only engaged (constantly meshed) to the engaging portion 46e of the first motor shaft 46, and the actuator 92 advances and retracts the movable engaging member EM2 in the axial direction of the first motor shaft 46, the second gear 62a, and the fourth gear 64a. As a result, the actuator 92 moves the movable engaging member EM2 and causes the movable engaging member EM2 to engage with both of the engaging portion 46e of the first motor shaft 46 and the engaging portion 61e of the second gear 62a, thereby allowing the connection of the first motor shaft 46 and the second gear 62a. The actuator 92 moves the movable engaging member EM2 and causes the movable engaging member EM2 to engage with both of the engaging portion 46e of the first motor shaft 46 and the engaging portion 63e of the third gear 63a, thereby allowing the connection of the first motor shaft 46 and the fourth gear 64a. A tapered portion TP as shown in FIG. 3 is formed at the edge in the tooth width direction of each dog tooth DT of the engaging portions 46e, 61e, 64e, and the movable engaging member EM2 so that easy, reliable, and appropriate meshing of the plurality of dog teeth DT of the movable engaging member EM2 and the dog teeth DT of the engaging portions 46e, 62e, and 64e is possible by pressing the movable engaging member EM2 against the engaging portions 46e, 62e, or 64e even when the plurality of dog teeth DT of the movable engaging member EM2 and the dog teeth DT of the engaging portions 46e, 62e, and 64e are unable to be meshed appropriately. The gears 62a and 62b of the second-speed gear trains, the gears 64a and 64b of the fourth-speed gear train, and the clutch C2 constitute a second transmission mechanism of the transmission 60.

The power transmitted from the carrier shaft 45a or the first motor shaft 46 to the counter shaft 65 is transmitted to the drive shaft 67 through the gears 65b and 66a (in the embodiment, the gear ratio between the gears 65a and the 66a is 1 to 1). The power is eventually outputted to rear wheels 69a and 69b as drive wheels through the differential gear 68. As in the transmission 60 of the embodiment, the installation of the clutches C1 and C2 on the carrier shaft 45a and the first motor shaft 46 side enables to reduce the loss when the clutches C1 and C2 fix the gears 61a to 64a to the carrier shaft 45a or the first motor shaft 46. More specifically, although depending on the ratio of the numbers of teeth in the gear trains, the rotation speed of the gear 64a running idle before being fixed to the first motor shaft 46 by the clutch C2 is lower than the rotation speed of the corresponding gear 64b on the counter shaft 65 side, especially in the second transmission mechanism including the fourth-speed gear train with a small reduction ratio. Therefore, if at least the clutch C2 is installed on the first motor shaft 46 side, the dog of the gear 64a and the dog of the first motor shaft 46 can be engaged with less loss. The clutch C1 may be installed on the counter shaft 65 side in the first transmission mechanism including the first-speed gear train with a large reduction ratio.

According to the transmission 60 configured this way, the power from the carrier shaft 45a can be transmitted to the drive shaft 67 through the first gear 61a (first-speed gear train) or the third gear 63a (third-speed gear train) and the counter shaft 65, if the clutch C2 is released and one of the first gear 61a (first-speed gear train) and the third gear 63a (third-speed gear train) is fixed to the carrier shaft 45a by the clutch C1. The power from the first motor shaft 46 can be transmitted to the drive shaft 67 through the second gear 62a (second-speed gear train) or the fourth gear 64a (fourth-speed gear train), and the counter shaft 65, if the clutch C0 is engaged, the clutch C1 is released, and one of the second gear 62a (second-speed gear train) and the fourth gear 64a (fourth-speed gear train) is fixed to the first motor shaft 46 by the clutch C2. Hereinafter, the state in which the power is transmitted using the first-speed gear train may be referred to as “first transmission state (first speed)”, the state in which the power is transmitted using the second-speed gear train may be referred to as “second transmission state (second speed)”, the state in which the power is transmitted using the third-speed gear train may be referred to as “third transmission state (third speed)”, and the state in which the power is transmitted using the fourth-speed gear train is referred to as “fourth transmission state (fourth speed)”.

The hybrid ECU 70 is configured as a microprocessor with a CPU 72 as a main component and includes, in addition to the CPU 72, a ROM 74 for storing various processing programs, a RAM 76 for temporarily storing data, a timer 78 that performs a timing process in accordance with a timing command, an input output port (not shown), a communication port (not shown), and the like. Data inputted to the hybrid ECU 70 through the input port includes an ignition signal from an ignition switch (start switch) 80, a shift position SP from a shift position sensor 82 that detects the shift position SP which is an operation position of a shift lever 81, an accelerator opening Acc from an accelerator pedal position sensor 84 that detects the depression of an accelerator pedal 83, a brake pedal position BP from a brake pedal position sensor 86 that detects the depression of a brake pedal 85, a vehicle velocity V from a vehicle velocity sensor 87, and a rotation speed Np from a rotation speed sensor 88 that detects the rotation speed Np of the drive shaft 67. As described, the hybrid ECU 70 is connected to the engine ECU 24, the motor ECU 30, and the battery ECU 36 through a communication port and exchanges various control signals and data with the engine ECU 24, the motor ECU 30, and the battery ECU 36. The hybrid ECU 70 further controls the clutch C0, and the actuators 90 to 92 of the clutches C1 and C2 of the transmission 60.

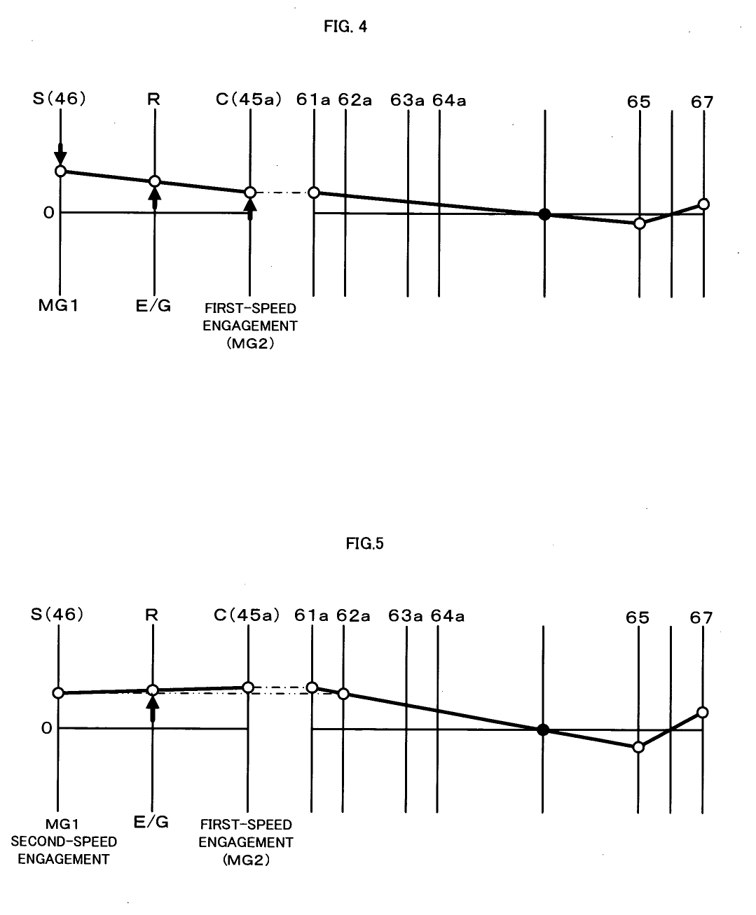

An outline of the operation of the hybrid vehicle 20 will be described with reference to FIGS. 4 to 13. In FIGS. 4 to 10, the S-axis denotes the rotation speed of the sun gear 41 of the power distribution and integration mechanism 40 (rotation speed Nm1 of the motor MG1, i.e., the first motor shaft 46), the R-axis denotes the rotation speed of the ring gear 42 of the power distribution and integration mechanism 40 (rotation speed Ne of the engine 22), and the C-axis denotes the rotation speed of the carrier 45 (carrier shaft 45a) of the power distribution and integration mechanism 40. The axes 61a to 64a, 65, and 67 denote the rotation speeds of the first to fourth gears 61a to 64a of the transmission 60, the counter shaft 65, and the drive shaft 67, respectively.

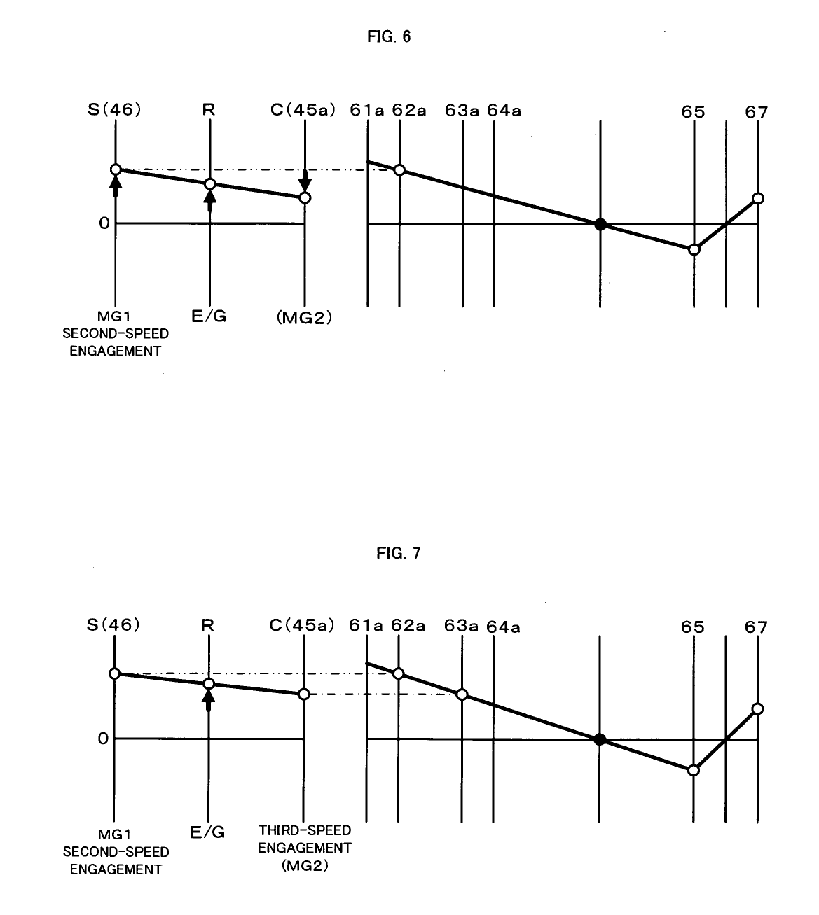

In the hybrid vehicle 20, the power from the carrier shaft 45a under the first transmission state (first speed) can be outputted to the drive shaft 67 by shifting the gear (decelerating) based on the gear ratio G(1) of the first-speed gear train (first gears 61a and 61b) as shown in FIG. 4, if the clutch C2 is released and the clutch C1 fixes the first gear 61a (first-speed gear train) to the carrier shaft 45a during running involving the engagement of the clutch C0 and the operation of the engine 22. As shown in FIG. 5, the clutch C2 can fix the second gear 62a (second-speed gear train) to the first motor shaft 46 while the first gear 61a (first-speed gear train) is being fixed by the clutch C1 to the carrier shaft 45a, if the first motor shaft 46 (sun gear 41) and the second gear 62a constantly meshed with the second gear 62b fixed to the counter shaft 65 are rotated and synchronized in accordance with the change in the vehicle velocity V (rotation speed of the drive shaft 67) under the first transmission state. Hereinafter, the state (FIG. 5) in which the first-speed gear train of the transmission 60 connects the carrier 45, which is a first rotating element of the power distribution and integration mechanism 40, to the drive shaft 67 and the second-speed gear train of the transmission 60 connects the sun gear 41, which is a second rotating element, to the drive shaft 67 is referred to as “1-2 speed simultaneous engagement state” or “first simultaneous engagement state”. The power (torque) from the engine 22 can be mechanically (directly) transmitted to the drive shaft 67 with a first fixed transmission gear ratio γ1 (=(1−ρ)·G(1)+ρ·G(2)), which is a value between the gear ratio G(1) of the first-speed gear train and the gear ratio G(2) of the second-speed gear train, without conversion to electrical energy, if the value of the torque command to the motors MG1 and MG2 is set to 0 under the 1-2 speed simultaneous engagement state. The rotation speeds of the sun gear 41 (motor MG1), the ring gear 42 (engine 22), and the carrier 45 (motor MG2) of the power distribution and integration mechanism 40 when the 1-2 speed simultaneous engagement state is realized are determined based on the gear ratios G(1), G(2) of the transmission 60 and the gear ratio ρ of the power distribution and integration mechanism 40 for each rotation speed (vehicle velocity V) of the drive shaft 67. If the clutch C1 is released under the 1-2 speed simultaneous engagement state shown in FIG. 5, the clutch C2 fixes only the second gear 62a (second-speed gear train) to the first motor shaft 46 (sun gear 41) as shown with a two-dot chain line in FIG. 6. As a result, under the second transmission state (second speed), the power from the first motor shaft 46 can be shifted based on the gear ratio G(2) of the second-speed gear train (second gears 62a and 62b) and outputted to the drive shaft 67.

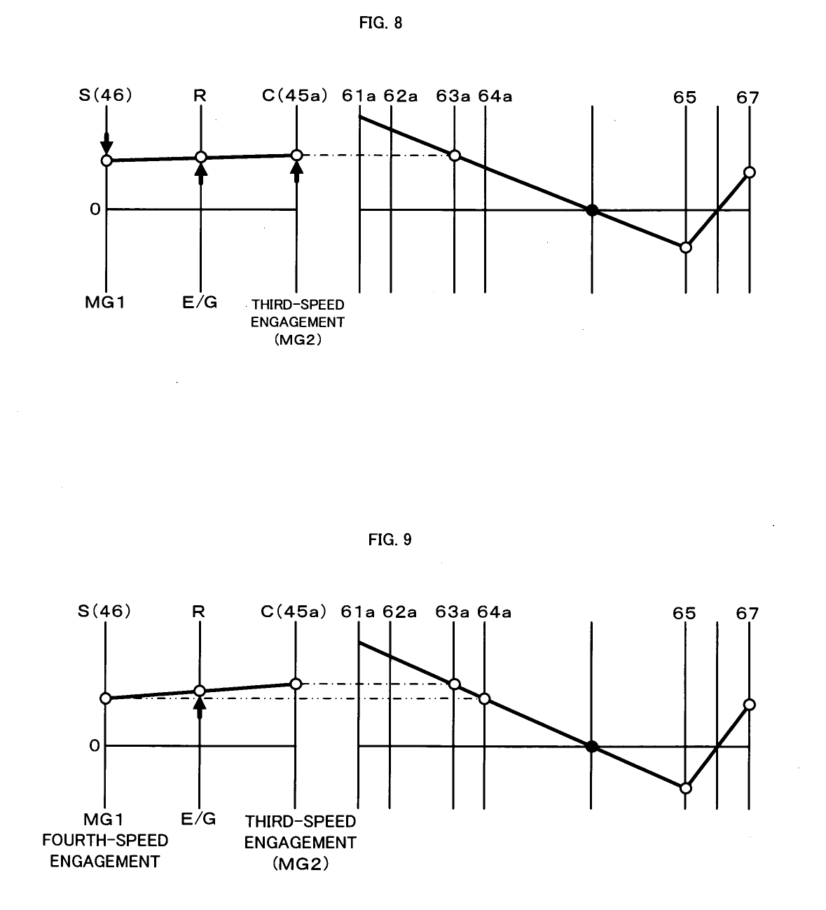

Similarly, as shown in FIG. 7, the clutch C1 can fix the third gear 63a (third-speed gear train) to the carrier shaft 45a while the second gear 62a (second-speed gear train) is being fixed by the clutch C2 to the first motor shaft 46, if the carrier shaft 45a (carrier 45) and the third gear 63a constantly meshed with the third gear 63b fixed to the counter shaft 65 are rotated and synchronized in accordance with the change in the vehicle velocity V under the second transmission state. Hereinafter, the state (FIG. 7) in which the second-speed gear train of the transmission 60 connects the sun gear 41, which is a second rotating element of the power distribution and integration mechanism 40, to the drive shaft 67 and the third-speed gear train of the transmission 60 connects the carrier 45, which is a first rotating element, to the drive shaft 67 is referred to as “2-3 speed simultaneous engagement state” or “second simultaneous engagement state”. The power (torque) from the engine 22 can be mechanically (directly) transmitted to the drive shaft 67 with a second fixed transmission gear ratio γ2 (=ρ·G(2)+(1−ρ)·G(3)), which is a value between the gear ratio G(2) of the second-speed gear train and the gear ratio G(3) of the second-speed gear train, without conversion to electrical energy, if the value of the torque command to the motors MG1 and MG2 is set to 0 under the 2-3 speed simultaneous engagement state. The rotation speeds of the sun gear 41 (motor MG1), the ring gear 42 (engine 22), and the carrier 45 (motor MG2) of the power distribution and integration mechanism 40 when the 2-3 speed simultaneous engagement state is realized are determined based on the gear ratios G(2), G(3) of the transmission 60 and the gear ratio ρ of the power distribution and integration mechanism 40 for each rotation speed (vehicle velocity V) of the drive shaft 67. If the clutch C2 is released under the 2-3 speed simultaneous engagement state shown in FIG. 7, the clutch C1 fixes only the third gear 63a (third-speed gear train) to the carrier shaft 45a (carrier 45) as shown with a one-dot chain line in FIG. 8. As a result, under the third transmission state (third speed), the power from the carrier shaft 45a can be shifted based on the gear ratio G(3) of the third-speed gear train (third gears 63a and 63b) and outputted to the drive shaft 67.

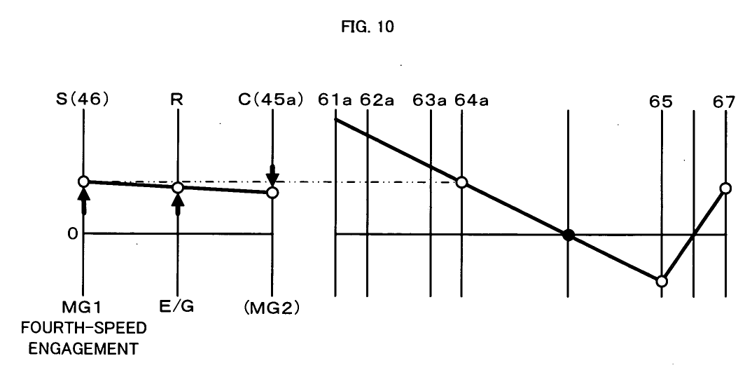

Furthermore, as shown in FIG. 9, the clutch C2 can fix the fourth gear 64a (fourth-speed gear train) to the first motor shaft 46 while the third gear 63a (third-speed gear train) is being fixed by the clutch C1 to the carrier shaft 45a, if the first motor shaft 46 (sun gear 41) and the fourth gear 64a constantly meshed with the fourth gear 64b fixed to the counter shaft 65 are rotated and synchronized in accordance with the change in the vehicle velocity V under the third transmission state. Hereinafter, the state (FIG. 9) in which the third-speed gear train of the transmission 60 connects the carrier 45, which is a first rotating element of the power distribution and integration mechanism 40, to the drive shaft 67 and the fourth-speed gear train of the transmission 60 connects the sun gear 41, which is a second rotating element, to the drive shaft 67 is referred to as “3-4 speed simultaneous engagement state” or “third simultaneous engagement state”. The power (torque) from the engine 22 can be mechanically (directly) transmitted to the drive shaft 67 with a third fixed transmission gear ratio γ3 (=(1−ρ)·G(3)+ρ·G(4)), which is a value between the gear ratio G(3) of the third-speed gear train and the gear ratio G(4) of the fourth-speed gear train, without conversion to electrical energy, if the value of the torque command to the motors MG1 and MG2 is set to 0 under the 3-4 speed simultaneous engagement state. The rotation speeds of the sun gear 41 (motor MG1), the ring gear 42 (engine 22), and the carrier 45 (motor MG2) of the power distribution and integration mechanism 40 when the 3-4 speed simultaneous engagement state is realized are determined based on the gear ratios G(3), G(4) of the transmission 60 and the gear ratio ρ of the power distribution and integration mechanism 40 for each rotation speed (vehicle velocity V) of the drive shaft 67. If the clutch C1 is released under the 3-4 speed simultaneous engagement state shown in FIG. 9, the clutch C2 fixes only the fourth gear 64a (fourth-speed gear train) to the first motor shaft 46 (sun gear 41) as shown with a two-dot chain line in FIG. 10. As a result, under the fourth transmission state (fourth speed), the power from the first motor shaft 46 can be shifted based on the gear ratio G(4) of the fourth-speed gear train (fourth gears 64a and 64b) and outputted to the drive shaft 67.

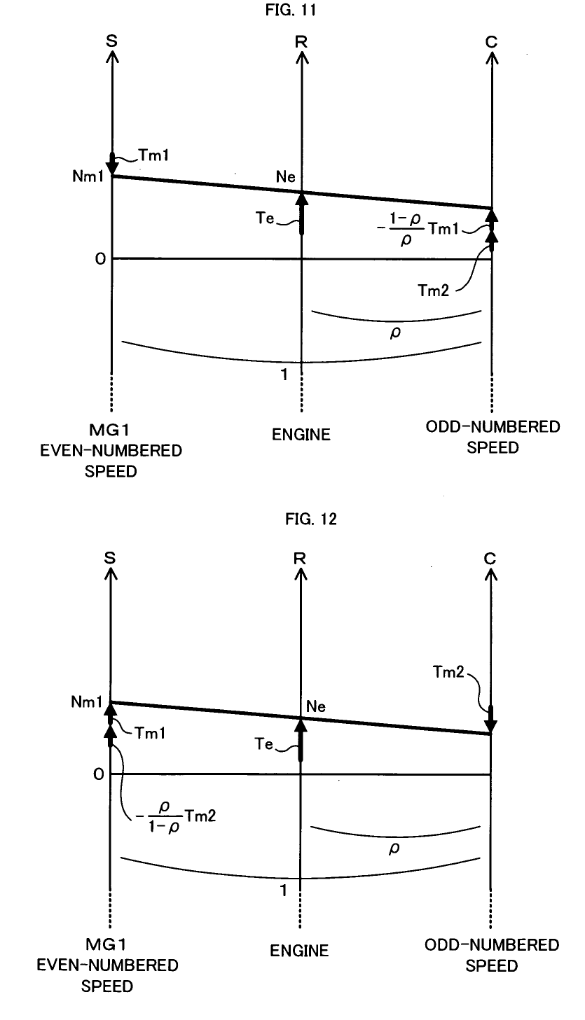

As described, setting up of the transmission 60 to the first or third transmission state upon running of the hybrid vehicle 20 involving the operation of the engine 22 enables to drive and control the motors MG1 and MG2, so that the carrier 45 of the power distribution and integration mechanism 40 serves as an output element, the motor MG2 connected to the carrier 45 functions as an electric motor, and the motor MG1 connected to the sun gear 41 serving as a reaction force element functions as a generator. In this case, the power distribution and integration mechanism 40 distributes the power from the engine 22 inputted through the ring gear 42 to the sun gear 41 side and the carrier 45 side in accordance with the gear ratio ρ, and integrates the power from the engine 22 and the power from the motor MG2 functioning as an electric motor and then outputs the power to the carrier 45 side. The mode in which the motor MG1 functions as a generator while the motor MG2 functions as an electric motor will be referred to as “first torque conversion mode”. In the first torque conversion mode, the power from the engine 22 is subjected to torque conversion by the power distribution and integration mechanism 40 and the motors MG1 and MG2 to output the power to the carrier 45 to thereby control the rotation speed of the motor MG1. As a result, the ratio between the rotation speed Ne of the engine 22 and the rotation speed of the carrier 45, which is an output element, can be steplessly and continuously changed. FIG. 11 depicts an example of an alignment chart illustrating the relationship between the rotation speeds and torque of the elements of the power distribution and integration mechanism 40 in the first torque conversion mode. In FIG. 11, the S-axis, the R-axis, and the C-axis denote like axes as those in FIGS. 4 to 10, reference character p denotes the gear ratio (the number of teeth of the sun S gear 41/the number of teeth of the ring gear 42) of the power distribution and integration mechanism 40, and thick arrows on the axes denote torque acting on corresponding elements. In FIG. 11, the rotation speeds of the S-axis, the R-axis, and the C-axis exhibit positive values above the 0-axis (horizontal axis) and exhibit negative values below the 0-axis. The thick arrows in FIG. 11 denote torque acting on the elements, and the value of the torque is positive when an arrow points upward in FIG. 11 while the value of the torque is negative when an arrow points downward in FIG. 11 (same in FIGS. 4 to 10, 12, and 13).

Furthermore, setting up of the transmission 60 to the second or fourth transmission state upon running of the hybrid vehicle 20 involving the operation of the engine 22 enables to drive and control the motors MG1 and MG2, so that the sun gear 41 of the power distribution and integration mechanism 40 serves as an output element, the motor MG1 connected to the sun gear 41 functions as an electric motor, and the motor MG2 connected to the carrier 45 serving as a reaction force element functions as a generator. In this case, the power distribution and integration mechanism 40 distributes the power from the engine 22 inputted through the ring gear 42 to the sun gear 41 side and the carrier 45 side in accordance with the gear ratio ρ, and integrates the power from the engine 22 and the power from the motor MG1 functioning as an electric motor and then outputs the power to the sun gear 41 side. The mode in which the motor MG2 functions as a generator while the motor MG1 functions as an electric motor will be referred to as “second torque conversion mode”. In the second torque conversion mode, the power from the engine 22 is subjected to torque conversion by the power distribution and integration mechanism 40 and the motors MG1 and MG2 to output the power to the sun gear 41 to thereby control the rotation speed of the motor MG2. As a result, the ratio between the rotation speed Ne of the engine 22 and the rotation speed of the sun gear 41, which is an output element, can be steplessly and continuously changed. FIG. 12 depicts an example of an alignment chart illustrating the relationship between the rotation speeds of the elements of the power distribution and integration mechanism 40 and the torque in the second torque conversion mode.

The first torque conversion mode and the second torque conversion mode are alternately switched along with the change in the transmission state (transmission gear ratio) of the transmission 60 in the hybrid vehicle 20 of the embodiment, thereby avoiding the rotation speed Nm1 or Nm2 of the motor MG1 or MG2 functioning as a generator from becoming a negative value, especially when the rotation speed Nm2 or Nm1 of the motor MG2 or MG1 functioning as an electric motor has increased. Therefore, in the hybrid vehicle 20, generation of a power cycle can be controlled, the power cycle in which the motor MG2 generates electricity using part of the power outputted to the carrier shaft 45a when the rotation speed of the motor MG1 becomes negative under the first torque conversion mode and the motor MG1 consumes the electric power generated by the motor MG 2 to output power, or in which the motor MG1 generates electricity using part of the power outputted to the first motor shaft 46 when the rotation speed of the motor MG2 becomes negative under the second torque conversion mode and the motor MG2 consumes the electric power generated by the motor MG1 to output power, thereby enabling to improve the transmission efficiency of power in a wider operating range. The maximum rotation speeds of the motors MG1 and MG2 can be controlled along with the control of such a power cycle, allowing miniaturization of the motors MG1 and MG2. Furthermore, in the hybrid vehicle 20, the power from the engine 22 can be mechanically (directly) transmitted to the drive shaft 67 with transmission gear ratios (fixed transmission gear rations γ(1) to γ(3)) specific to the 1-2 speed simultaneous engagement state, the 2-3 speed simultaneous engagement state, and the 3-4 speed simultaneous engagement state, thereby increasing the opportunities to mechanically output the power from the engine 22 to the drive shaft 67 without conversion to electrical energy and enabling to further improve the transmission efficiency of power in a wider operating range. In general, in a power output apparatus using an engine, two electric motors, and a differential rotation mechanism such as a planetary gear mechanism, more power from the engine is converted to electrical energy when the reduction ratio between the engine and the drive shaft is relatively large. Therefore, the transmission efficiency of power is deteriorated, and the motors MG1 and MG2 tend to generate heat. As a result, the simultaneous engagement mode is especially advantageous when the reduction ratio between the engine 22 and the drive shaft is relatively large.

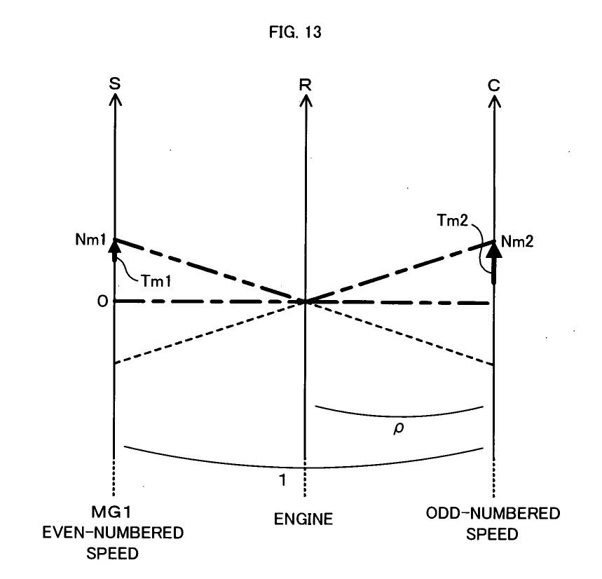

An outline of a motor running mode for outputting power from the motors MG1 or MG2 using electric power from the battery 35 with the engine 22 halted to thereby run the hybrid vehicle 20 will now be described with reference to FIG. 13 and the like. In the hybrid vehicle 20 of the embodiment, the motor running mode is roughly classified into a clutch-engaged first motor running mode, a clutch-released first motor running mode, and a second motor running mode. When performing the clutch-engaged first motor running mode, the clutch C0 is engaged, and then the first gear 61a of the first-speed gear train of the transmission 60 or the third gear 63a of the third-speed gear train is fixed to the carrier shaft 45a to cause only the motor MG2 to output power, or, the second gear 62a of the second-speed gear train of the transmission 60 or the fourth gear 64a of the fourth-speed gear train is fixed to the first motor shaft 46 to cause only the motor MG1 to output power. The clutch C0 connects the sun gear 41 of the power distribution and integration mechanism 40 and the first motor shaft 46 in the clutch-engaged first motor running mode. Therefore, the motor MG1 or MG2 that is not outputting power is co-rotated by the motor MG2 or MG1 that is outputting power and runs idle (see, dotted line in FIG. 13). When performing the clutch-released first motor running mode, the clutch C0 is released, and then the first gear 61a of the first-speed gear train of the transmission 60 or the third gear 63a of the third-speed gear train is fixed to the carrier shaft 45a to cause only the motor MG2 to output power, or, the second gear 62a of the second-speed gear train of the transmission 60 or the fourth gear 64a of the fourth-speed gear train is fixed to the first motor shaft 46 to cause only the motor MG1 to output power. In the clutch-released first motor running mode, the clutch C0 is released and the connection between the sun gear 41 and the first motor shaft 46 is released as shown with a one-dot chain line and a two-dot chain line in FIG. 13. Therefore, the co-rotation of the crankshaft 26 of the engine 22 stopped by the function of the power distribution and integration mechanism 40 is prevented, and the co-rotation of the motor MG1 or MG2 being stopped by the release of the clutch C2 or C1 is prevented. This enables to prevent the reduction of the transmission efficiency of power. When performing the second motor running mode, the clutch C0 is released, the transmission 60 is set to the 1-2 speed simultaneous engagement state, the 2-3 speed simultaneous engagement state, or the 3-4 speed simultaneous engagement state using the clutch C1 or C2, and then at least one of the motors MG1 and MG2 is driven and controlled. This allows both of the motors MG1 and MG2 to output power while preventing the co-rotation of the engine 22, and large power can be transmitted to the drive shaft 67 in the motor running mode. Therefore, so-called hill start can be suitably performed, and towing performance or the like during the motor running can be suitably acquired.

In the hybrid vehicle 20 of the embodiment, once the clutch-released first motor running mode is selected, the transmission state (transmission gear ratio) of the transmission 60 can be easily changed so that the power can be efficiently transmitted to the drive shaft 67. For example, switching to the 1-2 speed simultaneous engagement state, the 2-3 speed simultaneous engagement state, or the 3-4 speed simultaneous engagement state, i.e., switching to the second motor running mode, can be performed if the rotation speed of the stopped motor MG1 is synchronized with the rotation speed of the second gear 62a of the second-speed gear train or the fourth gear 64a of the fourth-speed gear train, and if the clutch C2 fixes the second gear 62a or the fourth gear 64a to the first motor shaft 46, when the first gear 61a of the first-speed gear train of the transmission 60 or the third gear 63a of the third-speed gear train is fixed to the carrier shaft 45a and the power is outputted only from the motor MG2 under the clutch-released first motor running mode. In this state, if the clutch C1 of the transmission 60 is released and the power is outputted only from the motor MG1, the power outputted by the motor MG1 can be transmitted to the drive shaft 67 through the second-speed gear train of the transmission 60 or the fourth-speed gear train. As a result, the rotation speed of the carrier shaft 45a or the first motor shaft 46 can be shifted using the transmission 60 to amplify the torque in the hybrid vehicle 20 of the embodiment, even in the motor running mode. Therefore, the maximum torque demanded to the motors MG1 and MG2 can be reduced, and the motors MG1 and MG2 can be miniaturized. The simultaneous engagement state of the transmission 60, i.e., the second motor running mode, is temporarily performed when changing the transmission gear ratio of the transmission 60 during the motor running. Therefore, so-called torque loss does not occur during changing of the transmission gear ratio, and the transmission gear ratio can be changed highly smoothly without shock. When the power demand is increased or the state of charge SOC of the battery 35 is reduced in these motor running modes, the motor MG1 or MG2 that will not output power in accordance with the transmission gear ratio of the transmission 60 will crank the engine 22 to start the engine 22.

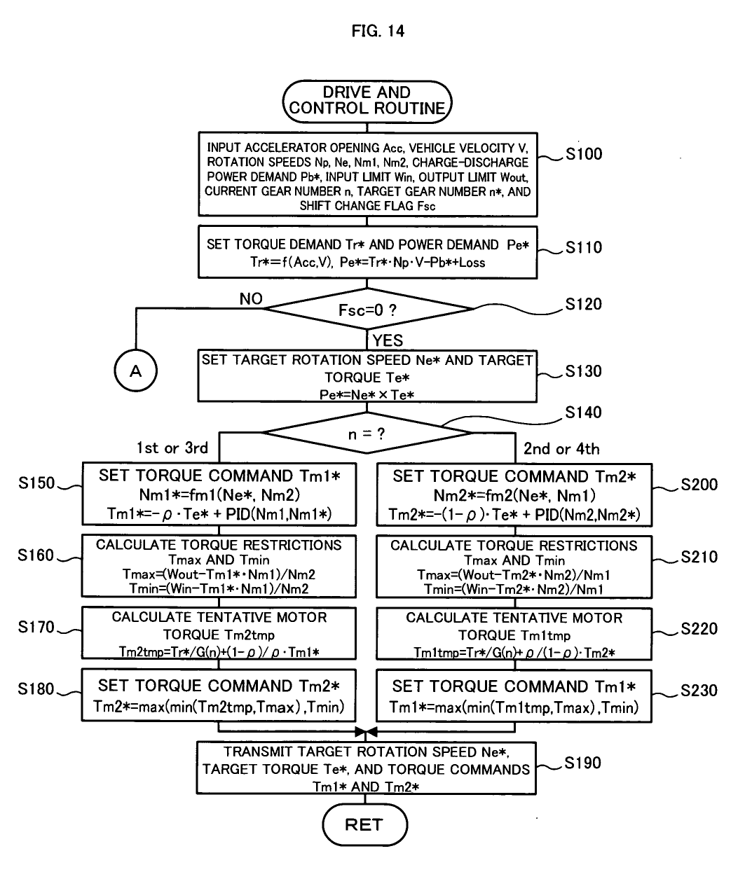

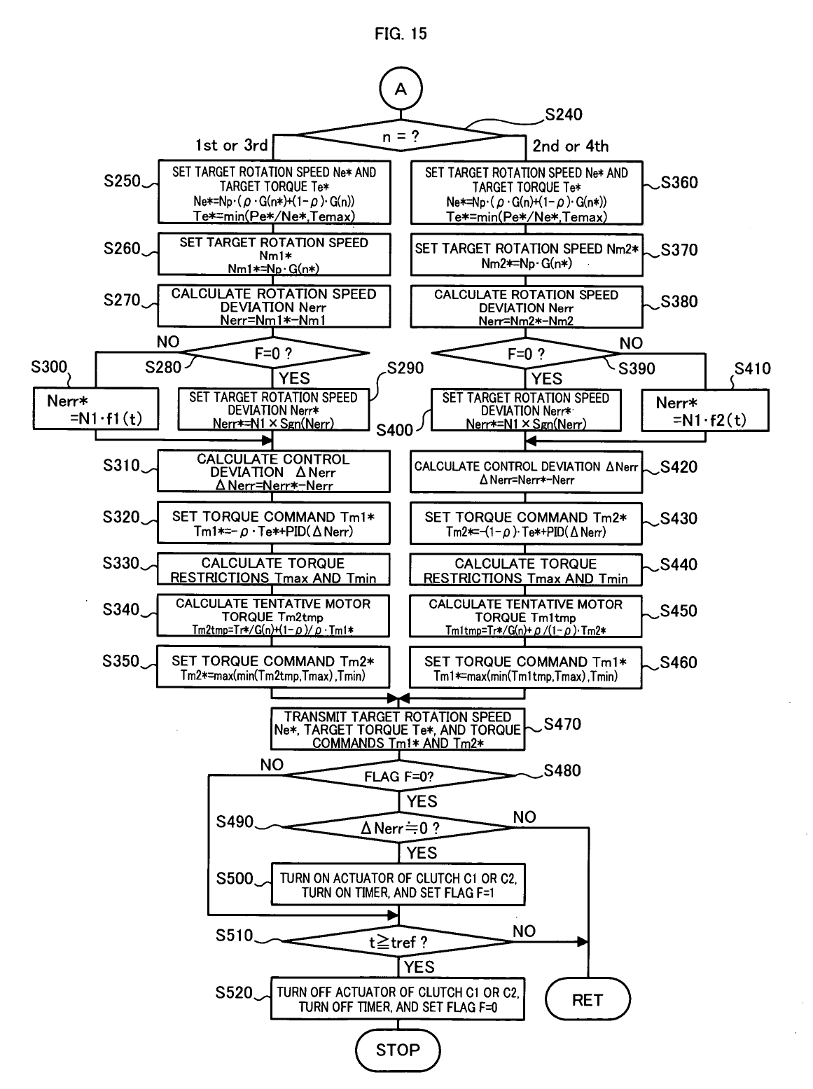

A control procedure of the clutches C1 and C2 when changing the transmission state (transmission gear ratio) of the transmission 60 upon running of the hybrid vehicle 20 involving the engagement of the clutch C0 and the operation of the engine 22 will be specifically described with reference to FIGS. 14 to 18. FIGS. 14 and 15 are flow charts showing an example of a drive and control routine performed every predetermined time (for example, every several msec) by the hybrid ECU 70 upon running of the hybrid vehicle 20 involving the engagement of the clutch C0 and the operation of the engine 22.

When starting the drive and control routine of FIGS. 14 and 15, the CPU 72 of the hybrid ECU 70 performs an input process of data required for the control, such as the accelerator opening Acc from the accelerator pedal position sensor 84, the vehicle velocity V from the vehicle velocity sensor 87, the rotation speed Np of the drive shaft 67 from the rotation speed sensor 88, the rotation speed Ne of the engine 22 (crankshaft 26), the rotation speeds Nm1 and Nm2 of the motors MG1 and MG2, the charge-discharge power demand Pb*, the input limit Win and the output limit Wout of the battery 35, the current gear number n (n=1, 2, 3, or 4 in the embodiment) and the target gear number n* (similarly, n*=1, 2, 3, or 4 in the embodiment) of the transmission 60, and the value of the shift change flag Fsc (step S100). In this case, the rotation speed Ne of the engine 22 is calculated based on a signal from a crank position sensor (not shown) and inputted from the engine ECU 24 through communication, while the rotation speeds Nm1 and Nm2 of the motors MG1 and MG2 are inputted from the motor ECU 30 through communication. The battery ECU 36 inputs the charge-discharge power demand Pb* (exhibits a positive value during discharge in the embodiment), the input limit Win of the battery 35, and the output limit Wout through communication. The current gear number n denotes the one that is provided for the connection of the carrier shaft 45a or the first motor shaft 46 of the first- to fourth-speed gear trains of the transmission 60 and the drive shaft 67, and is stored in a predetermined area of the RAM 76 when the carrier shaft 45a or the first motor shaft 46 and the drive shaft 67 are connected through one of the first- to fourth-speed gear trains. The target gear number n* and the shift change flag Fsc are set up through a transmission determination routine (not shown) performed separately by the hybrid ECU 70. In the transmission determination routine, for example, once predetermined transmission state switching requirements, which are related to a vehicle velocity V (rotation speed Np of the drive shaft 67), an accelerator opening Acc, and the like that are determined in advance in consideration of the transmission efficiency between the engine 22 and the drive shaft 67, the performances and heat generations of the motors MG1 and MG2, the gear ratios G(1) to G(4) of the transmission 60, and the like, are met, the hybrid ECU 70 sets the value of the shift change flag FSC to 1, the value being 0 when the transmission state (transmission gear ratio) of the transmission 60 is maintained. In accordance with the states or the like of the vehicle velocity V and the accelerator opening Acc, the hybrid ECU 70 further adds 1 to the current gear number n and sets the value as the target gear number n* if the hybrid vehicle 20 is in acceleration and subtracts 1 from the current gear number n and sets the value as the target gear number n* if the hybrid vehicle 20 is in deceleration.

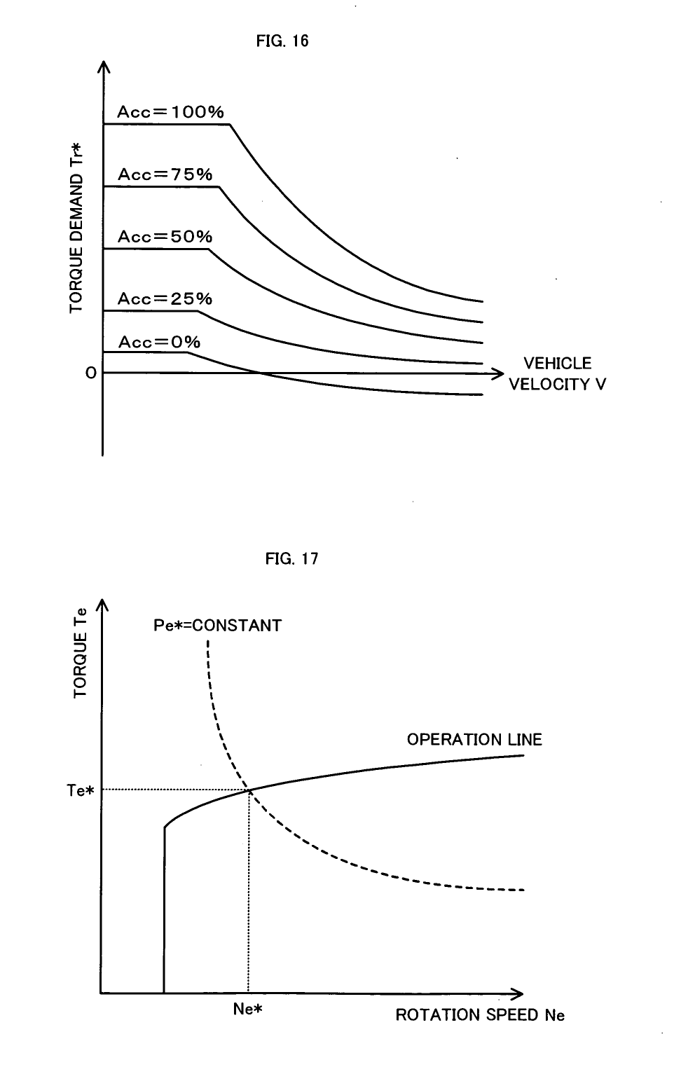

Subsequent to the data input process of step S100, a torque demand Tr* to be outputted to the drive shaft 67 is set up based on the inputted accelerator opening Acc and the vehicle velocity V, and a power demand Pe* demanded to the engine 22 is set up (step S110). In the embodiment, a torque demand setting map in which the relationship between the accelerator opening Acc, the vehicle velocity V, and the torque demand Tr* is defined in advance is stored in the ROM 74, and the torque demand Tr* corresponding to the given accelerator opening Acc and the vehicle velocity V is delivered and set up from the map. FIG. 16 depicts an example of the torque demand setting map. In the embodiment, the power demand Pe* is calculated by multiplying the torque demand Tr* set up in step S110 by the rotation speed Np of the drive shaft 67 and by adding the charge-discharge power demand Pb* and the loss Loss (sum of the mechanical loss in torque conversion by the power distribution and integration mechanism 40 and the electrical loss associated with the drive of the motors MG1 and MG2). Whether the value of the shift change flag Fsc inputted in step S100 is 0 is then determined (step S120). If the value of the shift change flag Fsc is 0 and there is no need to change the transmission state (transmission gear ratio) of the transmission 60 (when the transmission state switching requirements are not met), the target rotation speed Ne* of the engine 22 and the target torque Te* are set up based on the power demand Pe* set up in step S110 (step S130). In this case, the target rotation speed Ne* and the target torque Te* are set up based on the predetermined operation line and the power demand Pe* so as to efficiently operate the engine 22 to further improve the fuel consumption. FIG. 17 illustrates a correlation curve (equal power line) of the operation line of the engine 22, the engine rotation speed Net and the engine torque Te. As shown in FIG. 17, the target rotation speed Ne* and the target torque Te* can be obtained as an intersection of the operation line and the correlation curve showing that the power demand Pe* (Ne×Te) is constant.

After setting up the target rotation speed Ne* and the target torque Te*, which of the values from 1 to 4 (which of the first- to fourth-speed gear trains) is the current gear number n inputted in step S100 is determined (step S140). The carrier shaft 45a is connected to the drive shaft 67 by the transmission 60 if the value of the current gear number n is 1 or 3. Therefore, the target rotation speed Nm1* of the motor MG1 is calculated in accordance with following formula (1) using the target rotation speed Ne* set up in step S130, the rotation speed Nm2 of the motor MG2 corresponding to the rotation speed of the carrier shaft 45a (carrier 45), and the gear ratio ρ of the power distribution and integration mechanism 40, and then formula (2) based on the calculated target rotation speed Nm1* and the current rotation speed Nm1 is calculated to set up a torque command Tm1* of the motor MG1 (step S150). Formula (1) is a dynamic relational expression in relation to the rotating element of the power distribution and integration mechanism 40. Formula (1) can be easily delivered from the alignment chart of FIG. 11. Formula (2) is a relational expression in feedback control for rotating the motor MG1 at the target rotation speed Nm1*. In formula (2), “k11” of the second term of the right hand member denotes a gain of the proportional term, while “k12” of the third term of the right hand member denotes a gain of the integral term. The deviation of the input limit Win and the output limit Wout of the battery 35 and the power consumption (generated output) of the motor MG1 obtained as the product of the torque command Tm1* of the motor MG1 set up in step S150 and the current rotation speed Nm1 of the motor MG1 is divided by the rotation speed Nm2 of the motor MG2 to obtain torque restrictions Tmin and Tmax as upper and lower limits of torque allowed to output from the motor MG2 (step S160). Furthermore, tentative motor torque Tm2tmp as torque to be outputted from the motor MG2 is calculated in accordance with formula (3) using the torque demand Tr*, the torque command Tm1*, the gear ratio G(n) of the gear train corresponding to the current gear number n, and the gear ratio ρ of the power distribution and integration mechanism 40 (step S170). Formula (3) can be easily delivered from the alignment chart of FIG. 11. The calculated tentative motor torque Tm2tmp is then restricted by the torque restrictions Tmax and Tmin calculated in step S160 to set up a torque command Tm2* of the motor MG2 (step S180). Setting up of the torque command Tm2* of the motor MG2 this way enables to establish the torque outputted to the carrier shaft 45a as torque restricted within the range of the input limit Win and the output limit Wout of the battery 35. After setting up the target rotation speed Ne* and the target torque Te* of the engine 22 as well as the torque commands Tm1* and Tm2* of the motors MG1 and MG2, the target rotation speed Ne* and the target torque Te* of the engine 22 are transmitted to the engine ECU 24 while the torque commands Tm1* and Tm2* of the motors MG1 and MG2 are transmitted to the motor ECU 30 (step S190), and the processes subsequent to step S100 are again executed. Receiving the target rotation speed Ne* and the target torque Te*, the engine ECU 24 executes control to obtain the target rotation speed Ne* and the target torque Te*. Receiving the torque commands Tm1* and Tm2*, the motor ECU 30 controls switching of the switching elements of the inverters 31 and 32 so that the motor MG1 is driven in accordance with the torque command Tm1* while the motor MG2 is driven in accordance with the torque command Tm2*.

Nm1*=1/ρ·(Ne*−(1−ρ)·Nm2) (1)

Tm1*=−ρ·Te*+k11·(Nm1*−Nm1)+k12·∫(Nm1*−Nm1)·dt (2)

Tm2tmp=Tr*/G(n)+(1−ρ)/ρ·Tm1* (3)

The first motor shaft 46 is connected to the drive shaft 67 by the transmission 60 if the current gear number n is 2 or 4. Therefore, the target rotation speed Nm2* of the motor MG2 is calculated in accordance with following formula (4) using the target rotation speed Ne* set up in step S130, the rotation speed Nm1 of the motor MG1 corresponding to the rotation speed of the first motor shaft 46 (sun gear 41), and the gear ratio ρ of the power distribution and integration mechanism 40, and then formula (5) based on the calculated target rotation speed Nm2* and the current rotation speed Nm2 is calculated to set up the torque command Tm2* of the motor MG2 (step S200). Formula (4) is also a dynamic relational expression in relation to the rotating element of the power distribution and integration mechanism 40. Formula (4) can be easily delivered from the alignment chart of FIG. 12. Formula (5) is a relational expression in feedback control for rotating the motor MG2 at the target rotation speed Nm2*. In formula (5), “k21” of the second term of the right hand member denotes a gain of the proportional term, while “k22” of the third term of the right hand member denotes a gain of the integral term. The deviation of the input limit Win and the output limit Wout of the battery 35 and the power consumption (generated output) of the motor MG2 obtained as the product of the torque command Tm2* of the motor MG2 set up in step S200 and the current rotation speed Nm2 of the motor MG2 is divided by the rotation speed Nm1 of the motor MG1 to obtain torque restrictions Tmin and Tmax as upper and lower limits of torque allowed to output from the motor MG1 (step S210). Furthermore, tentative motor torque Tm1tmp as torque to be outputted from the motor MG1 is calculated in accordance with formula (6) using the torque demand Tr*, the torque command Tm2*, the gear ratio G(n) of the gear train corresponding to the current gear number n, and the gear ratio ρ of the power distribution and integration mechanism 40 (step S220). Formula (6) can be easily delivered from the alignment chart of FIG. 12. The calculated tentative motor torque Tm1tmp is then restricted by the torque restrictions Tmax and Tmin calculated in step S210 to set up the torque command Tm1* of the motor MG1 (step S230). Setting up of the torque command Tm1* of the motor MG1 this way enables to establish the torque outputted to the first motor shaft 46 as torque restricted within the range of the input limit Win and the output limit Wout of the battery 35. After setting up the target rotation speed Ne* and the target torque Te* of the engine 22 as well as the torque commands Tm1* and Tm2* of the motors MG1 and MG2, the target rotation speed Ne* and the target torque Te* of the engine 22 are transmitted to the engine ECU 24, while the torque commands Tm1* and Tm2* of the motors MG1 and MG2 are transmitted to the motor ECU 30 (step S190), and the processes after step S100 are again executed.

Nm2*=(Ne*−ρ·Nm1)/(1−ρ) (4)

Tm2*=−(1−ρ)·Te*+k21·(Nm2*−Nm2)+k22·∫(Nm2*−Nm2)·dt (5)

Tm1tmp=Tr*/G(n)+ρ/(1−ρ)·Tm2* (6)

Meanwhile, if the value of the shift change flag Fsc is 1 and it is determined that the transmission state (transmission gear ratio) of the transmission 60 should be changed (when the transmission state switching requirements are met) in step S120, which of the values from 1 to 4 (which of the first- to fourth-speed gear trains) is the current gear number n inputted in step S100 is determined as shown in FIG. 15 (step S240). If the current gear number n is 1 or 3, the target rotation speed Ne* of the engine 22 is set up in accordance with following formula (7) based on the rotation speed Np of the drive shaft 67 inputted in step S100, the gear ratio ρ of the power distribution and integration mechanism 40, the gear ratio G(n) of the gear train corresponding to the current gear number n, and the gear ratio G(n*) of the gear train corresponding to the target gear number n*, and the target torque Te* of the engine 22 is set up based on the set target rotation speed Ne*, the power demand Pe* set up in step S110, and the like (step S250). In formula (7), “(ρ·G(n*)+(1−ρ)·G(n)” denotes an N-th fixed transmission gear ratio γ(N) in an N-th simultaneous engagement state (“N” is a value from 1 to 3) based on the current gear number n and the target gear number n*, with γ(N) being any one of the first to third fixed transmission gear ratios γ(1) to γ(3) in the 1-2 speed simultaneous engagement state, the 2-3 speed simultaneous engagement state, and the 3-4 speed simultaneous engagement state. In other words, in step S250, the rotation speed of the engine 22 in the N-th simultaneous engagement state corresponding to the rotation speed Np (vehicle velocity V) of the drive shaft 67 is set up as the target rotation speed Ne*. In step S250, the smaller one of the division of the power demand Pe* set up in step S110 by the target rotation speed Ne* and rated torque Temax of the engine 22 is set up as the target torque Te* of the engine 22. Subsequently, the rotation speed of the motor MG1 under the N-th simultaneous engagement state corresponding to the rotation speed Np of the drive shaft 67 is set up as the target rotation speed Nm1* (step S260). As shown in FIG. 15, the target rotation speed Nm1* can be obtained by multiplying the rotation speed Np of the drive shaft 67 inputted in step S100 by the gear ratio G(n*) of the gear train corresponding to the target gear number n*. After setting up the target rotation speed Nm1* of the motor MG1, the current rotation speed Nm1 of the motor MG1 inputted in step S100 is subtracted from the target rotation speed Nm1* of the motor MG1 to obtain a rotation speed deviation Nerr that is a deviation of the rotation speed of the first motor shaft 46 (second element) from the rotation speed of the second or fourth gear 62a or 64a (first element) (step S270). Whether the value of a predetermined flag F is 0 is further determined (step S280). If the value of the flag F is 0, the value obtained by multiplying a predetermined, relatively small positive value N1 by a sign Sng (Nerr) of the rotation speed deviation Nerr calculated in step S270 is set up as the target rotation speed Nerr* (step S290). The target rotation speed deviation Nerr* is a targeted value of deviation of the rotation speed of the first motor shaft 46 from the rotation speed of the second or fourth gear 62a or 64a. When the process of step S290 is executed, the target rotation speed deviation Nerr* is set to a negative, relatively small constant value (−N1) if the current rotation speed Nm1 of the motor MG1 is greater than the target rotation speed Nm1* and the rotation speed deviation Nerr is negative. On the other hand, the target rotation speed deviation Nerr* is set to a positive, relatively small constant value (N1) if the current rotation speed Nm1 of the motor MG1 is smaller than the target rotation speed Nm1* and the rotation speed deviation Nerr is positive. After setting up the target rotation speed deviation Nerr*, the rotation speed deviation Nerr calculated in step S270 is subtracted from the set target rotation speed deviation Nerr* to obtain a control deviation ΔNerr provided for the following control (step S310). Subsequently, formula (8) based on the control deviation ΔNerr set up in step S310 is calculated to set up the torque command Tm1* of the motor MG1 (step S320). Formula (8) is a relational expression in feedback control for matching the rotation speed deviation Nerr of the rotation speed of the first motor shaft 46 from the second or fourth gear 62a or 64a to the target rotation speed deviation Nerr*, i.e., for rotating the motor MG1 at a rotation speed which can be obtained by adding the target rotation speed deviation Nerr* to the target rotation speed Nm1*. In formula (8), “k31” of the second term of the right hand member denotes a gain of the proportional term, while “k32” of the third term of the right hand member denotes a gain of the integral term. After setting up the torque command Tm1* to the motor MG1 this way, processes of step S330 to S350, the similar to the processes in steps S160 to S180, are executed to set up the torque command Tm2* to the motor MG2.

Ne*=Np·(ρ·G(n*)+(1−ρ)·G(n)) (7)

Tm1*=−ρ·Te*+k31·ΔNerr+k32·∫ΔNerr·dt (8)

If the current gear number n is 2 or 4, the target rotation speed Ne* of the engine 22 is set up in accordance with following formula (9) based on the rotation speed Np of the drive shaft 67 inputted in step S100, the gear ratio ρ of the power distribution and integration mechanism 40, the gear ratio G(n) of the gear train corresponding to the current gear number n, and the gear ratio G(n*) of the gear train corresponding to the target gear number n*, and the target torque Te* of the engine 22 is set up based on the set target rotation speed Ne*, the power demand Pe* set up in step S110, and the like (step S360). In formula (9), “ρ·G(n)+(1−ρ)·G(n*)” denotes the N-th fixed transmission gear ratio γ(N) in the N-th simultaneous engagement state based on the current gear number n and the target gear number n*, with γ(N) being any one of the first to third fixed transmission gear ratios γ(1) to γ(3) in the 1-2 speed simultaneous engagement state, the 2-3 speed simultaneous engagement state, or the 3-4 speed simultaneous engagement state. In other words, in step S360 as well, the rotation speed of the engine 22 in the N-th simultaneous engagement state corresponding to the rotation speed Np (vehicle velocity V) of the drive shaft 67 is set up as the target rotation speed Ne*. In step S360 as well, the smaller one of the division of the power demand Pe* set up in step S110 by the target rotation speed Ne* and the rated torque Temax of the engine 22 is set up as the target torque Te* of the engine 22. Subsequently, the rotation speed of the motor MG2 under the N-th simultaneous engagement state corresponding to the rotation speed Np of the drive shaft 67 is set up as the target rotation speed Nm2* (step S370). As shown in FIG. 15, the target rotation speed Nm2* can be obtained by multiplying the rotation speed Np of the drive shaft 67 inputted in step S100 by the gear ratio G(n*) of the gear train corresponding to the target gear number n*. After setting up the target rotation speed Nm2* of the motor MG2, the current rotation speed Nm2 of the motor MG2 inputted in step S100 is subtracted from the target rotation speed Nm2* of the motor MG2 to obtain the rotation speed deviation Nerr that is a deviation of the rotation speed of the carrier shaft 45a (second element) from the rotation speed of the first or third gear 61a or 63a (first element) (step S380). Whether the value of a predetermined flag F is 0 is further determined (step S390). If the value of the flag F is 0, the value obtained by multiplying a predetermined, relatively small positive value N1 by a sign Sng (Nerr) of the rotation speed deviation Nerr calculated in step S380 is set up as the target rotation speed deviation Nerr* (step S400). When the process of step S400 is executed, the target rotation speed deviation Nerr* is set to a negative, relatively small constant value (−N1) if the current rotation speed Nm2 of the motor MG2 is greater than the target rotation speed Nm2* and the rotation speed deviation Nerr is negative. On the other hand, the target rotation speed deviation Nerr* is set to a positive, relatively small constant value (N1) if the current rotation speed Nm2 of the motor MG2 is smaller than the target rotation speed Nm2* and the rotation speed deviation Nerr is positive. After setting up the target rotation speed deviation Nerr*, the control deviation ΔNerr provided for the subsequent control is obtained by subtracting the rotation speed deviation Nerr calculated in step S380 from the set target rotation speed deviation Nerr* (step S420). Subsequently, formula (10) based on the control deviation ΔNerr and the like set up in step S420 is calculated to set up the torque command Tm2* of the motor MG2 (step S430). Formula (10) is a relational expression in feedback control for matching the rotation speed deviation Nerr of the rotation speed of the carrier shaft 45a from the rotation speed of the first or third gear 61a or 63a to the target rotation speed deviation Nerr*, i.e., for rotating the motor MG2 at the rotation speed obtained by adding the target rotation speed deviation Nerr* to the target rotation speed Nm2*. In formula (10), “k41” of the second term of the right hand member denotes a gain of the proportional term, while “k42” of the third term of the right hand member denotes a gain of the integral term. After setting up the torque command Tm2* to the motor MG2, processes of steps S440 to S460, which are similar to the processes of steps S210 to S230, are executed to set up the torque command Tm1* to the motor MG1.

Ne*=Np·(ρ·G(n)+(1−ρ)·G(n*)) (9)

Tm2*=−(1−ρ)·Te*+k411]ΔNerr+k42·∫ΔNerr·dt (10)

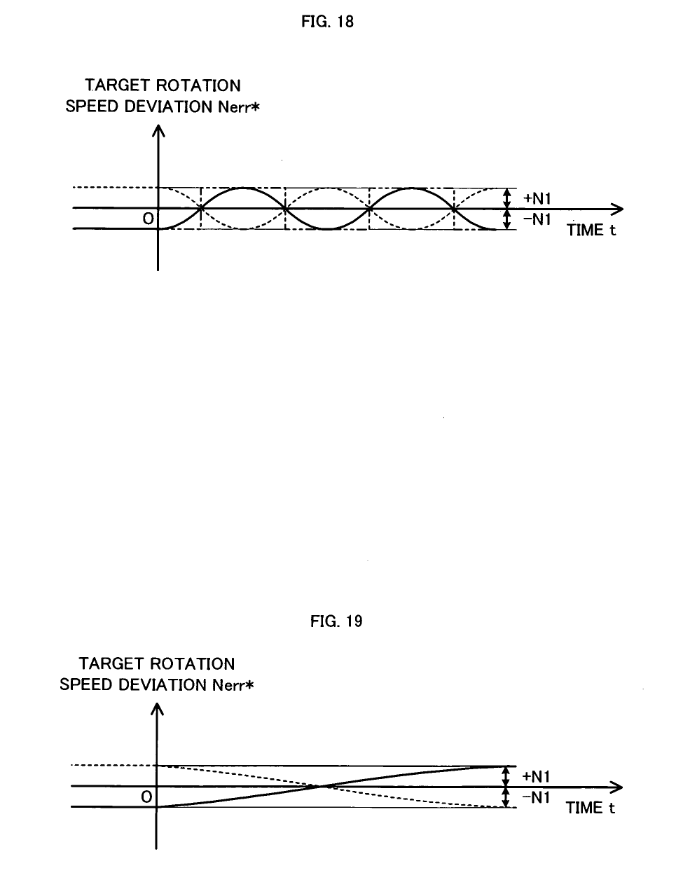

After setting the target rotation speed Ne* and the target torque Te* of the engine 22 and the torque commands Tm1* and Tm2* to the motors MG1 and MG2 as described, the target rotation speed Ne* and the target torque Te* of the engine 22 are transmitted to the engine ECU 24, and the torque commands Tm1* and Tm2* of the motors MG1 and MG2 are transmitted to the motor ECU 30 (step S470). After execution of the data transmission process of step S470, whether the value of the flag F is 0 is determined (step S480). If the value of the flag F is determined to be 0 in step S480, whether the value of the control deviation ΔNerr set up in step S310 or S420 has become substantially 0 is determined (step S490). If the control deviation ΔNerr has not become substantially 0, the processes after step S100 are again executed. If the control deviation ΔNerr has become substantially 0 in step S490 and if it is determined that the rotation speed deviation Nerr of the rotation speed Nm1 or Nm2 of the motor MG1 or MG2 corresponding to the sun gear 41 (first motor shaft 46) or the carrier 45 (carrier shaft 45a) that has not been connected to the drive shaft 67 by the transmission 60 from the rotation speed of any of the first to fourth gears 61a to 64a of the transmission 60 corresponding to the target gear number n* substantially matches the target rotation speed deviation Nerr*, the actuator 91 or 92 of the clutch C1 or C2 corresponding to the target gear number n* inputted in step S100 is turned on, the movable engaging member EM1 or EM2 is moved toward the engaging portion 61e, 62e, 63e, or 64e of the gear train corresponding to the target gear number n*, the timer 78 is turned on, and the value of the flag F is set to 1 (step S500). Whether an elapsed time t from when the value of the control deviation ΔNerr timed by the timer 78 has become substantially 0 is equal to or greater than a predetermined clutch engagement time tref is determined (step S510). If the elapsed time t is less than the clutch engagement time tref, the processes after step S100 are again executed. The clutch engagement time tref is defined as a time from when the engagement of the engaging portion 45e or 46e with any of the engaging portions 61e to 64e has surely completed based on the performances of the actuators 91 and 92, distances between the engaging portion 45e or 46e and the engaging portions 61e to 64e, and the like. After the value of the flag F is set to 1 in step S500, it is determined that the value of the flag F is 1 in step S280 or S390 upon the next execution of the present routine. In this case, in step S300 or S410, the target rotation speed deviation Nerr* is set up to be periodically changed based on the elapsed time t timed by the timer 78. In the embodiment, the value of the target rotation speed deviation Nerr*, which has been set to, for example, −N1, is set up using a predetermined periodic function f1(t) or f2(t) so that the value gradually changes in the course of time, such as 0→N1→0→−N1, in step S300 as shown with a solid line in FIG. 18. In step S410, the value of the target rotation speed deviation Nerr*, which has been set to, for example, N1, is set up so that the value gradually changes in the course of time, such as 0→−N1→0→N1, as shown with a dotted line in FIG. 18. Once the value of the flag F is set to 1 in step S500, the processes of steps S490 and S500 are skipped and whether the elapsed time t is equal to or greater than the predetermined clutch engagement time tref is determined in step S510 upon the next execution of the present routine. If the elapsed time t is less than the clutch engagement time tref, the processes after step S100 are again executed. When the elapsed time t becomes equal to or greater than the clutch engagement time tref, the actuator 91 or 92 of the clutch C1 or C2 corresponding to the target gear number n* inputted in step S100 is turned off, the movement to one of the engaging portions 61e to 64e of the movable engaging member EM1 or EM2 is halted, the timer 78 is turned off, the value of the flag F is set to 0 (step S520), and the present routine is terminated.

This enables to easily and smoothly connect the first motor shaft 46 or the carrier shaft 45a to the drive shaft 67 by the gear train corresponding to the target gear number n* while preventing the shock, with the carrier shaft 45a or the first motor shaft 46 being connected to the drive shaft 67 by the gear train corresponding to the current gear number n, thereby realizing the N-th simultaneous engagement state corresponding to the current gear number n and the target gear number n*. Upon running of the hybrid vehicle 20 under the N-th simultaneous engagement state after the termination of the drive and control routine of FIGS. 14 and 15 through the process of step S520, the output torque of the motors MG1 and MG2 is adjusted so that the motors MG1 and MG2 will not substantially output torque, the engine 22 then outputs the target torque Te* based on the torque demand Tr*, and the engine 22 and the motors MG1 and MG2 are controlled so that, for example, one of the motors MG1 and MG2 will not output torque and that the other of the motors MG1 and MG2 will output torque based on the shortfall of torque of the engine 22 with respect to the torque demand Tr*. To change the transmission state of the transmission 60 after the termination of the drive and control routine of FIGS. 14 and 15 through the process of step S520 so that only the gear train corresponding to the target gear number n* connects one of the carrier 45 and the sun gear 41 to the drive shaft 67, a power exchanging process is executed in which the torque is exchanged between the motors MG1 and MG2 under the N-th simultaneous engagement state so that the motors MG1 and MG2 respectively output torque that should be outputted in the post-transmission state of connecting only one of the carrier 45 and the sun gear 41 is connected to the drive shaft 67. Consequently, the connection between the carrier 45 or the sun gear 41 and the drive shaft 67 by the gear train corresponding to the current gear number n of the transmission 60 is released.

As described, the transmission 60 provided in the hybrid vehicle 20 of the embodiment includes the clutches C1 and C2 capable of engaging the movable engaging member EM1 or EM2 only to the engaging portion 45e of the carrier shaft 45a or the engaging portion 46e of the first motor shaft 46 to thereby release the connection of the carrier shaft 45a with the first or third gear 61a or 63a, or the connection of the first motor shaft 46 with the second or fourth gear 62a or 64a, and capable of engaging the movable engaging member EM1 or EM2 to both of the engaging portion 45e of the carrier shaft 45a and the engaging portion 61e or 63e, or both of the engaging portion 46e of the first motor shaft 46 and the engaging portion 62e or 64e to thereby connect the carrier shaft 45a to the first or third gear 61a or 63a, or the first motor shaft 46 to the second or fourth gear 62a or 64a. In the hybrid vehicle 20, when the engine 22 is operated with the transmission 60 connecting one of the carrier shaft 45a and the first motor shaft 46 to the drive shaft 67 and the value of the shift change flag Fsc is set to 1 while the motors MG1 and MG2 are driven and controlled, the rotation speed adjustment processes (steps S240 to S350 and S470, or S240, S360 to S460, and S470) are executed in which the rotation speed deviation Nerr of the rotation speed Nm1 or Nm2 of the motor MG1 or MG2 corresponding to the other of the sun gear 41 (first motor shaft 46) or the carrier 45 (carrier shaft 45a) that has not been connected to the drive shaft 67 by the transmission 60 from the rotation speed of one of the first to fourth gears 61a to 64a of the transmission 60 corresponding to the target gear number n* matches the target rotation speed deviation Nerr*. Furthermore, when the value of the control deviation ΔNerr becomes substantially 0 and the rotation speed deviation Nerr of the rotation speed Nm1 or Nm2 of the motor MG1 or MG2 corresponding to the first motor shaft 46 or the carrier shaft 45a that has not been connected to the drive shaft 67 by the transmission 60 from the rotation speed of one of the first to fourth gears 61a to 64a corresponding to the target gear number n* is determined to substantially match the target rotation speed deviation Nerr*, the actuator 91 or 92 is controlled for the predetermined clutch engagement time tref so that movable engaging member EM1 or EM2 of the clutch C1 or C2 corresponding to the target gear number n* moves toward the engaging portion 61e, 62e, 63e, or 64e of the gear train corresponding to the target gear number n* (steps S480 to S520). In this way, if the movable engaging member EM1 or EM2 is moved toward the engaging portion 61e, 62e, 63e, or 64e of the gear train corresponding to the target gear number n* when the rotation speed deviation Nerr of the rotation speed Nm1 or Nm2 of the motor MG1 or MG2 corresponding to the first motor shaft 46 or the carrier shaft 45a from the rotation speed of one of the first to fourth gears 61a to 64a corresponding to the target gear number n* substantially matches the target rotation speed deviation Nerr*, pressing of the movable engaging member EM1 or EM2 against one of the engaging portions 61e to 64e enables to appropriately mesh and smoothly engage the plurality of dog teeth DT of the movable engaging member EM1 or EM2 with the dog teeth DT of one of the engaging portions 61e to 64e, thereby connecting the first motor shaft 46 or the carrier shaft 45a that has not been connected to the drive shaft 67 by the transmission 60 to the drive shaft 67 through the gear train corresponding to the target gear number n*, even when the plurality of dog teeth DT of the movable engaging member EM1 or EM2 are not appropriately meshed with the plurality of dog teeth DT of one of the engaging portions 61e to 64e. Furthermore, if the actuator 91 or 92 is controlled for the predetermined clutch engagement time tref so that the movable engaging member EM1 or EM2 moves toward the engaging portion 61e, 62e, 63e, or 64e of the gear train corresponding to the target gear number n*, the connection of the first motor shaft 46 or the carrier shaft 45a with the gear train (drive shaft 67) corresponding to the target gear number n* can be completed without determining whether the movable engaging member EM1 or EM2 has completely engaged with both of the engaging portion 45e or 46e and one of the engaging portions 61e to 64e. Therefore, in the hybrid vehicle 20 of the embodiment, the first motor shaft 46 or the carrier shaft 45a and the gear train (drive shaft 67) corresponding to the target gear number n* can be easily and smoothly connected under simpler control as compared to the case with a control procedure in which, for example, the rotation angles of the engaging portions (dogs) to be connected are detected and whether the dog teeth of two engaging portions are appropriately meshed is determined based on the detected rotation angles. The transmission 60 is capable of selectively and efficiently transmitting the power from the carrier 45 and the sun gear 41 of the power distribution and integration mechanism to the drive shaft 67 by setting the transmission state (transmission gear ratio) in a plurality of stages as described above. As a result, the hybrid vehicle 20 of the embodiment easily and smoothly change the transmission state of the transmission 60, thereby enabling to suitably improve the transmission efficiency of power in a wider operating range and suitably improve the fuel consumption and the driving performance.

The possibility of the plurality of dog teeth DT of the movable engaging member EM1 or EM2 and the plurality of dog teeth DT of one of the engaging portions 61e to 64e hitting each other can be reduced if the movable engaging member EM1 or EM2 is approximated to one of the targeted engaging portions 61e to 64e in a state where a slight difference is formed between the rotation speeds of the first motor shaft 46 or the carrier shaft 45a (motor MG1 or MG2) and one of the first to fourth gears 61a to 64a corresponding to the target gear number n* as described in the embodiment, with the target rotation speed deviation Nerr* being a relatively small value other than 0. Forming a slight difference in the rotation speeds between the first motor shaft 46 or the carrier shaft 45a (motor MG1 or MG2) and one of the first to fourth gears 61a to 64a corresponding to the target gear number n* enables to promptly and appropriately mesh the plurality of dog teeth DT of the movable engaging member EM1 or EM2 with the plurality of dog teeth DT of one of the engaging portions 61e to 64e by pressing the movable engaging member EM1 or EM2 against one of the engaging portions 61e to 64e, even if the plurality of dog teeth DT of the movable engaging member EM1 or EM2 and the plurality of dog teeth DT of one of the engaging portions 61e to 64e hit each other when the movable engaging member EM1 or EM2 and one of the targeted engaging portions 61e to 64e are abutted. Setting the target rotation speed deviation Nerr* to a predetermined value other than 0 enables to press the movable engaging member EM1 or EM2 against one of the targeted engaging portions 61e to 64e to smoothly engage the member and the portion. Although the target rotation speed deviation Nerr* is a constant value other than 0 in step S290 or S400 in the example of FIG. 15, the target rotation speed deviation Nerr* set up in step S290 or S400 may be designed to temporally (periodically) change to any value other than 0.

In the embodiment above, the target rotation speed deviation Nerr* is periodically changed as illustrated in FIG. 18, if the value of the control deviation ΔNerr becomes substantially 0 and if it is determined that the rotation speed deviation Nerr of the rotation speed Nm1 or Nm2 of the motor MG1 or MG2 corresponding to the sun gear 41 (first motor shaft 46) or the carrier 45 (carrier shaft 45a) that has not been connected to the drive shaft 67 by the transmission 60 from the rotation speed of one of the first to fourth gears 61a to 64a of the transmission 60 corresponding to the target gear number n* substantially matches the target rotation deviation Nerr*. This enables to invert the sign of the rotation speed deviation Nerr at least once after the rotation speed deviation Nerr has temporarily matched the target rotation speed deviation Nerr*. In other words, after being temporarily matched, the rotation speed of the first motor shaft 46 or the carrier shaft 45a (motor MG1 or MG2) and the rotation speed of one of the first to fourth gears 61a to 64a of the transmission 60 corresponding to the target gear number n* can be made different again. As a result, the hybrid vehicle 20 of the embodiment enables to more suitably avoid the situation in which the movable engaging member EM1 or EM2 is pressed against one of the engaging portions 61e to 64e with excessive power being applied between the movable engaging member EM1 or EM2 and one of the engaging portions 61e to 64e, and to more surely obtain a state in which the dog teeth DT of the movable engaging member EM1 or EM2 and the dog teeth DT of the engaging portion 61e, 62e, 63e, or 64e appropriately mesh with each other. When periodically changing the target rotation speed deviation Nerr*, the sign of the target rotation speed deviation Nerr* may be periodically changed as shown with a two-dot line in FIG. 18. It is perceived that the state can be basically obtained in which the dog teeth DT of the movable engaging member EM1 or EM2 and the engaging portion 61e, 62e, 63e, or 64e appropriately mesh with each other, if the rotation speed deviation Nerr temporarily matches the target rotation speed deviation Nerr* and then the sign of the rotation speed deviation Nerr is inverted at least once. Therefore, in step S300 or S410 of FIG. 15, the target rotation speed deviation Nerr* may be temporally changed so that the rotation speed deviation Nerr temporarily matches the target rotation speed deviation Nerr* and then the sign of the rotation speed deviation Nerr is inverted at least once, as shown in FIG. 19.

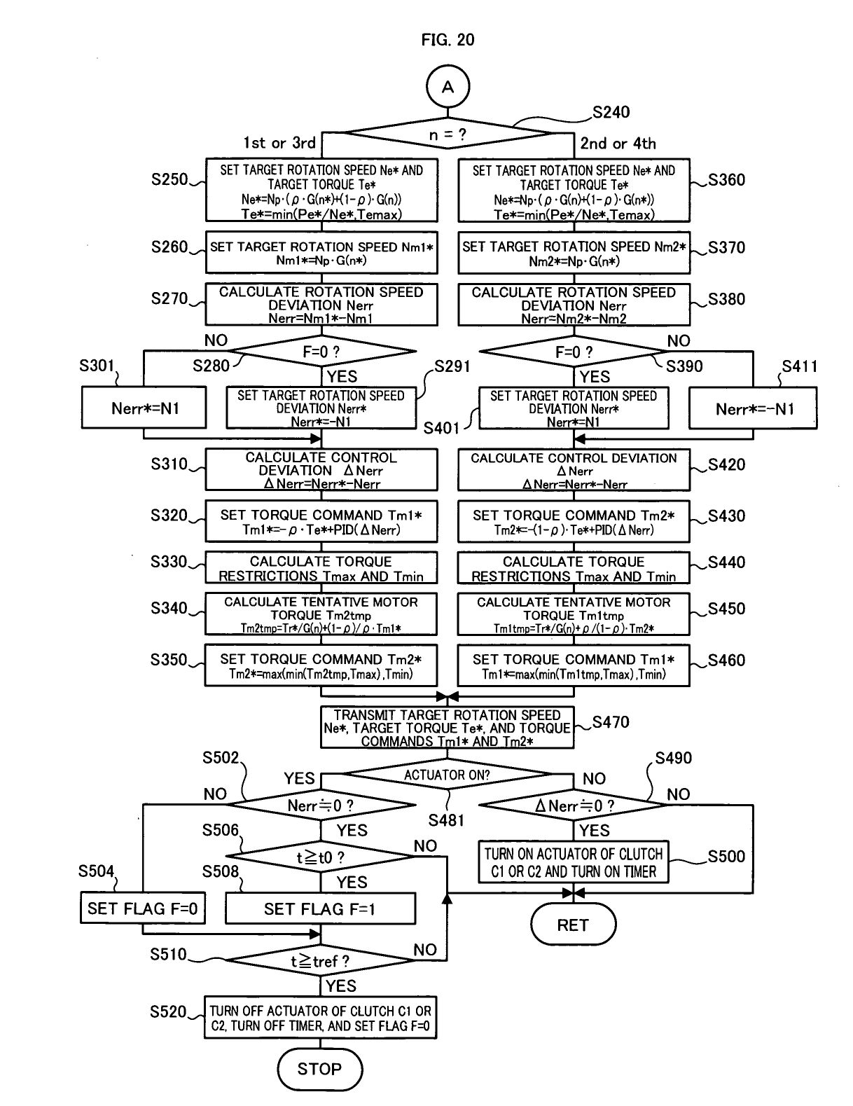

FIG. 20 is a flow chart showing another example of the drive and control routine executed by the hybrid ECU 70 and is equivalent to a modified example of the part shown in FIG. 15 related to the drive and control routine shown in FIGS. 14 and 15. The routine shown in FIG. 20 is different from the routine shown in FIG. 15 in regard to setting of the target rotation speed deviation Nerr*, the processes after the data transmission process of step S470, and the like. In the routine shown in FIG. 20, if the rotation speed Nm1 of the motor MG1 is to be adjusted to connect the first motor shaft 46 to the drive shaft 67 and if it is determined that the value of the flag F is 0 in step S280, the value of the target rotation speed deviation Nerr* is set to −N1 (N1 is a relatively small positive value) (step S291). If the rotation speed Nm2 of the motor MG2 is to be adjusted to connect the carrier shaft 45a to the drive shaft 67 and if it is determined that the value of the flag F is 0 in step S390, the value of the target rotation speed deviation Nerr* is set to N1 (step S401). In the routine shown in FIG. 20, after the data transmission process of step S470, whether one of the actuators 91 and 92 of the clutches C1 and C2 is in operation is determined (step S481). If the actuators 91 and 92 are not in operation, whether the control deviation ΔNerr set up in step S310 or S420 has become substantially 0 is further determined (step S490). If the control deviation ΔNerr has not become substantially 0, the processes after step S100 are again executed. If the control deviation ΔNerr is substantially 0 and it is determined that the rotation speed deviation Nerr of the rotation speed Nm1 or Nm2 of the motor MG1 or MG2 from the rotation speed of one of the first to fourth gears 61a to 64a corresponding to the target gear number n* substantially matches the target rotation speed deviation Nerr*, the actuator 91 or 92 of the clutch C1 or C2 corresponding to the target gear number n* is turned on, the movable engaging member EM1 or EM2 is moved toward the engaging portion 61e, 62e, 63e, or 64e of the gear train corresponding to the target gear number n*, the timer 78 is turned on (step S500), and the processes after step S100 are again executed. Once the actuator 91 or 92 is turned on in step S500, it is determined that one of the actuators 91 and 92 is turned on in step S480 upon the next execution of the present routine. In this case, whether the value of the rotation speed deviation Nerr calculated in step S270 or S380 is substantially 0 is determined (step S502). If the value of the rotation speed deviation Nerr is not substantially 0, the value of the flag F is set to 0 (step S504), whether the elapsed time t from when the control deviation ΔNerr timed by the timer 78 has become substantially 0 is equal to or greater than the clutch engagement time tref is determined (step S510), and the processes after step S100 are again executed if the elapsed time t is less than the clutch engagement time tref. If it is determined that the value of the rotation speed deviation Nerr has become substantially 0 in step S502, whether the elapsed time t timed by the timer 78 is equal to or greater than a predetermined time t0 shorter than the clutch engagement time tref is determined (step S506). The predetermined time t0 is defined as a time of the engaging portion 45e or 46e and one of the engaging portions 61e to 64e being engaged (begin to engage) when the dog teeth DT are appropriately meshed with each other. If it is determined that the elapsed time t is less than the predetermined time t0 in step S506, the processes after step S100 are again executed. If it is determined that the elapsed time t is equal to or greater than the predetermined time t0 in step S504, the value of the flag F is set to 1 (step S508), the determination process of step S510 is executed, and if the elapsed time t is less than the clutch engagement time tref, the processes after step S100 are again executed. Once the value of the flag F is set to 1 in step S508, it is determined that the value of the flag F is 1 in step S280 or S390 upon the next execution of the present routine. If the rotation speed Nm1 of the motor MG1 is to be adjusted to connect the first motor shaft 46 to the drive shaft 67 and it is determined that the value of the flag F is 1 in step S280, the value of the target rotation speed deviation Nerr* is set to 1, and the sign of the target rotation speed deviation Nerr* is inverted (step S301). If the rotation speed Nm2 of the motor MG2 is to be adjusted to connect the carrier shaft 45a to the drive shaft 67 and it is determined that the value of the flag F is 1 in step S390, the value of the target rotation speed deviation Nerr* is set to −N1, and the sign of the target rotation speed deviation Nerr* is inverted (step S411). In the routine of FIG. 20 as well, the actuator 91 or 92 of the clutch C1 or C2 corresponding to the target gear number n* inputted in step S100 is turned off when it is determined that the elapsed time t has become equal to or greater than the clutch engagement time tref in step S510, the movement of the movable engaging member EM1 or EM2 toward one of the targeted engaging portions 61e to 64e is halted, the timer 78 is turned off, the value of flag F is set to 0 (step S520), and the present routine is terminated.

When connecting the first motor shaft 46 or the carrier shaft 45a to one of the first to fourth gears 61a to 64a of the transmission 60 corresponding to the target gear number n* after setting the target rotation speed deviation Nerr* as a relatively small value other than 0 and forming a slight difference in the rotational speeds of the first motor shaft 46 or the carrier shaft 45a (motor MG1 or MG2) and one of the first to fourth gears 61a to 64a corresponding to the target gear number n*, the sign of the target rotation speed deviation Nerr* may be inverted if the value of the rotation speed deviation Nerr has become substantially 0 after the rotation speed deviation Nerr has temporarily matched the target rotation speed deviation Nerr*. More specifically, when applying the feedback control to the motor MG1 or MG2 so that the rotation speed deviation Nerr matches the target rotation speed deviation Nerr*, torque may be outputted from the motor MG1 or MG2 more than necessary caused by dispersion of the control variable or other reasons. Thus, the power may be transmitted from the first motor shaft 46 or the carrier shaft 45a to one of the first to fourth gears 61a to 64a of the transmission 60 corresponding to the target gear number n* more than necessary, or smooth engagement of the engaging portion 45e or 46e with the engaging portion 61e, 62e, 63e, or 64e of the gear train corresponding to the target gear number n* may be interfered. Under the circumstances, as in the routine of FIG. 20, if the sign of the target rotation speed deviation Nerr* is inverted when the rotation speed deviation Nerr has become substantially 0 after the rotation speed deviation Nerr has temporarily matched the target rotation speed deviation Nerr* (step S301 or S411), the output of torque from the motor MG1 or MG2 more than necessary caused by dispersion of the control variable or other reasons can be prevented, the transmission of excessive torque from the first motor shaft 46 or the carrier shaft 45a to one of the first to fourth gears 61a to 64a of the transmission 60 corresponding to the target gear number n* can be prevented, and the smooth engagement of the engaging portion 45e or 46e with the engaging portion 61e, 62e, 63e, or 64e of the gear train corresponding to the target gear number n* can be realized. The target rotation speed deviation Nerr* is set up as a constant value in step S291 or S401 of the routine of FIG. 20. This arrangement is, however, not restrictive in any sense. The target rotation speed deviation Nerr* set up in step S291 or S401 may be designed, for example, to temporally (periodically) change as long as the value is not 0. In that case, the sign of the previous value may be inverted to set the value as the target rotation speed deviation Nerr* in step S301 or S411.

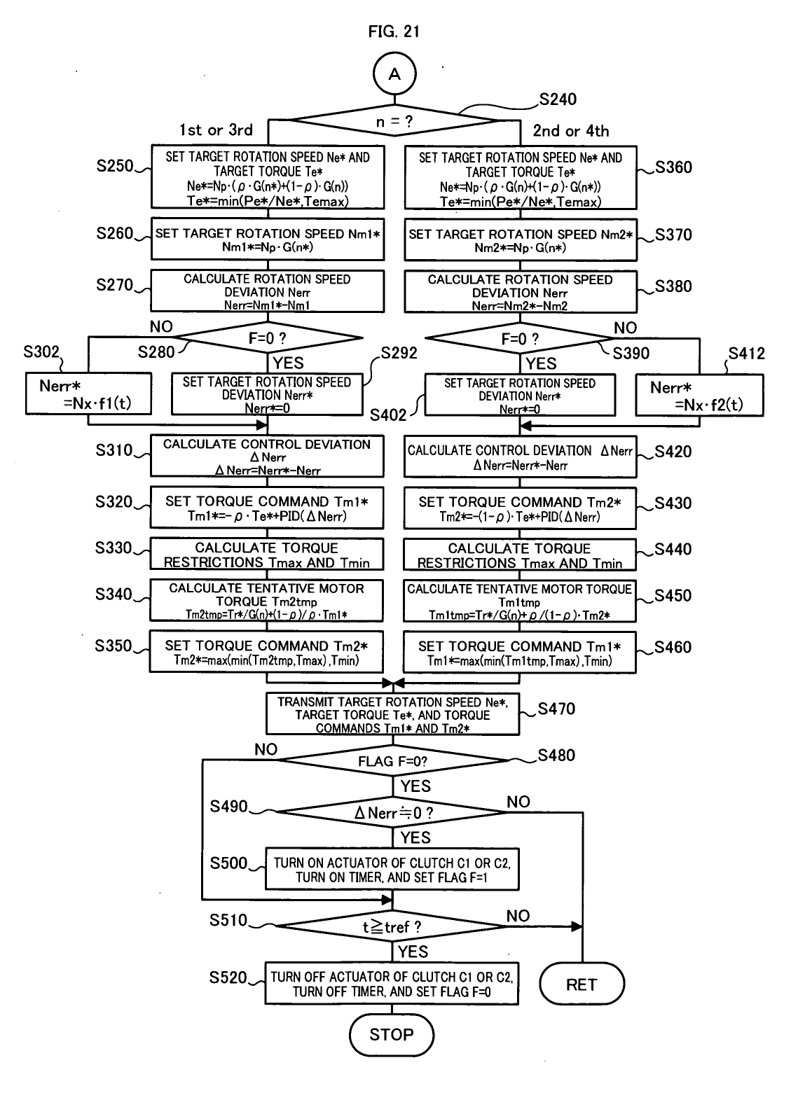

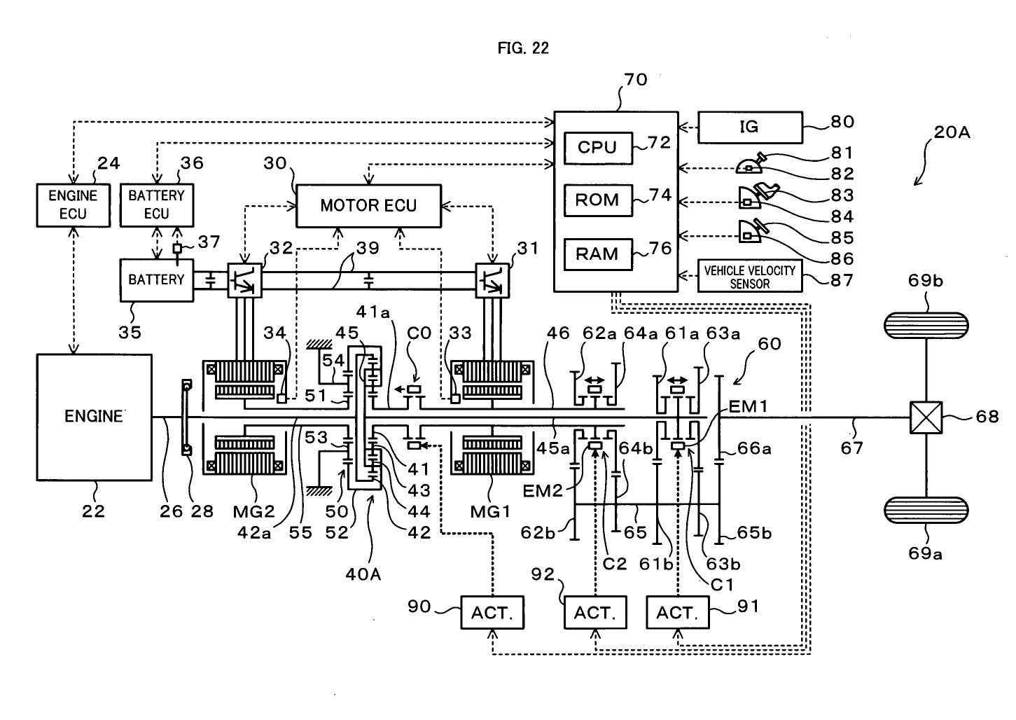

FIG. 21 is a flow chart showing still another example of the drive and control routine executed by the hybrid ECU 70 and is equivalent to a modified example of the part shown in FIG. 15 related to the drive and control routine shown in FIGS. 14 and 15. The routine shown in FIG. 21 is different from the routine shown in FIG. 15 in regard to the setting of the target rotation speed deviation Nerr* and the like. In the routine shown in FIG. 21, if the rotation speed Nm1 of the motor MG1 is to be adjusted to connect the first motor shaft 46 to the drive shaft 67 and it is determined that the value of the flag F is 0 in step S280, the value of the target rotation speed deviation Nerr* is set to 0 (step S292). Similarly, when the rotation speed Nm2 of the motor MG2 is to be adjusted to connect the carrier shaft 45a to the drive shaft 67 and it is determined that the value of the flag F is 0 in step S390, the value of the target rotation speed deviation Nerr* is set to 0 (step S402). Thus, in the routine of FIG. 21, if the value of the shift change flag Fsc is 1 and it is determined that the transmission state (transmission gear ratio) of the transmission 60 should be changed, the feedback control is applied to the motor MG1 or MG2 so that the rotation speed Nm1 or Nm2 of the motor MG1 or MG2 matches the target rotation speed Nm1* or Nm2* set up in step S260 or S370. If it is determined that the value of the control deviation ΔNerr has become substantially 0 in step S490 and if the actuator 91 or 92 of the clutch C1 or C2 corresponding to the target gear number n* or the timer 78 is turned on and the value of the flag F is set to 1 in step S500, it is determined that the value of the flag F is 1 in step S280 or S390 upon the next execution of the present routine, and the target rotation speed deviation Nerr* is set up to periodically change based on the elapsed time t timed by the timer 78 in step S302 or S412. In the embodiment, a value Nx, which is based on the tooth thickness and the backlash of the dog teeth DT of the engaging portions 45e and 46e, and the predetermined periodic function f1(t) or f2(t) are used to set up the target rotation speed deviation Nerr* to gradually change in the course of time, such as Nx→0→−Nx→0, in step S302 and to set up the target S rotation speed deviation Nerr* to gradually change in the course of time, such as −Nx→0→Nx→0 in step S412. The value Nx is defined as a value in which an angle based on the tooth thickness and the backlash of the dog teeth DT of the engaging portion 45e and 46e is converted to the rotation speeds of the motors MG1 and MG2. In the routine of FIG. 21 as well, when the elapsed time t is determined to be equal to or greater than the clutch engagement time tref in step S510, the actuator 91 or 92 of the clutch C1 or C2 corresponding to the target gear number n* inputted in step S100 is turned off, the movement of the movable engaging member EM1 or EM2 toward the engaging portion 61e, 62e, 63e, or 64e of the gear train corresponding to the target gear number n* is halted, the timer 78 is turned off, the value of the flag F is set to 0 (step S520), and the present routine is terminated.

In this way, the situation, in which the movable engaging member EM1 or EM2 is pressed against one of the engaging portions 61e to 64e with excessive power being applied between the movable engaging member EM1 or EM2 and one of the targeted engaging portions G1e to 64e, can also be prevented by causing the plurality of dog teeth DT of the movable engaging member EM1 or EM2 and the plurality of dog teeth DT of one of the engaging portions 61e to 64e to appropriately mesh with each other, when setting the value of the target rotation speed deviation Nerr* to 0 and changing the target rotation speed deviation Nerr* for the value of Nx at least once after the rotation speed deviation Nerr has matched the target rotation speed deviation Nerr*. The plurality of dog teeth DT of the movable engaging member EM1 or EM2 and the plurality of dog teeth DT of one of the targeted engaging portions 61e to 64e can be more surely and appropriately meshed with each other if the value Nx is set up based on the tooth thickness and the backlash of the dog teeth DT of the engaging portions 45e and 46e. The routine of FIG. 21 may also be used as a fail-safe in the case where a control procedure is employed in which the rotation angle of the engaging portions (dogs) to be connected is detected and whether the dog teeth of two engaging portions are appropriately meshed with each other is determined based on the detected rotation angle. Instead of setting the value of the target rotation speed deviation Nerr* to 0 and changing the target rotation speed deviation Nerr* for the value of Nx at least once after the rotation speed deviation Nerr has matched the target rotation speed deviation Nerr*, the feedback control of the motor MG1 or MG2 may be ceased and the absolute value of the torque command to the motor MG1 or MG2 may be decreased for a predetermined amount, after setting the value of the target rotation speed deviation Nerr* to 0 and the rotation speed deviation Nerr has matched the target rotation speed deviation Nerr*.

The hybrid vehicle 20 described above includes the power distribution and integration mechanism 40 configured to have 0.5 gear ratio ρ. This arrangement is, however, not restrictive in any sense, and the power distribution and integration mechanism may be configured to have a gear ratio ρ other than 0.5. FIG. 22 depicts a hybrid vehicle 20A having a power distribution and integration mechanism 40A which is a double-pinion planetary gear mechanism with a gear ratio ρ less than 0.5. The hybrid vehicle 20A includes a reduction gear mechanism 50 arranged between the power distribution and integration mechanism 40A and the engine 22. The reduction gear mechanism 50 is configured as a single-pinion planetary gear mechanism including a sun gear 51 of the external gear connected to the rotor of the motor MG2 through the second motor shaft 55, a ring gear 52 of the internal gear disposed concentrically with the sun gear 51 and fixed to the carrier 45 of the power distribution and integration mechanism 40A, a plurality of pinion gears 53 meshed with both of the sun gear 51 and the ring gear 52, and a carrier 54 holding the plurality of rotatable and revolvable pinion gears 53 and fixed to the transmission case. With the action of the reduction gear mechanism 50, the power from the motor MG2 is decreased and inputted to the carrier 45 of the power distribution and integration mechanism 40A, while the power from the carrier 45 is increased and inputted to the motor MG2. As such, more torque is distributed from the engine 22 to the carrier 45 than to the sun gear 41 when the power distribution and integration mechanism 40A that is a double-pinion planetary gear mechanism with the gear ratio ρ less than 0.5 is adopted. As a result, the arrangement of the reduction gear mechanism 50 between the carrier 45 of the power distribution and integration mechanism 40A and the motor MG2 enables to miniaturize the motor MG2 and reduce the power loss of the motor MG2. As in the embodiment, arranging the reduction gear mechanism 50 between the motor MG2 and the power distribution and integration mechanism 40A to integrate with the power distribution and integration mechanism 40A enables to further miniaturize the power output apparatus. In the example of FIG. 22, if the reduction gear mechanism 50 is configured so that the reduction ratio (the number of teeth of the sun gear 51/the number of teeth of the ring gear 52) is close to ρ/(1−ρ), with ρ being the gear ratio of the power distribution and integration mechanism 40A, the specifications of the motors MG1 and MG2 can be made the same, thereby improving the productivity of the hybrid vehicle 20A and the power output apparatus mounted thereon and reducing the cost.

Instead of the power distribution and integration mechanisms 40 and 40A, the hybrid vehicles 20 and 20A described above may have a power distribution and integration mechanism constituted as a planetary gear mechanism including a first sun gear and a second sun gear having different numbers of teeth and a carrier holding at least one step gear connecting a first pinion gear meshed with the first sun gear and a second pinion gear meshed with the second sun gear. In the hybrid vehicles 20 and 20A, the clutch C0 is arranged between the sun gear 41, which is a second rotating element of the power distribution and integration mechanisms 40 and 40A, and the motor MG1 as a second electric motor, and the clutch C0 connects and releases both components. This arrangement is, however, not restrictive in any sense. The clutch C0 may be arranged between the carrier 45, which is a first rotating element of the power distribution and integration mechanisms 40 and 40A, and the motor MG2 as a first electric motor, the clutch C0 connecting and releasing both components. The clutch C0 may also be arranged between the ring gear 42, which is a third rotating element of the power distribution and integration mechanisms 40 and 40A, and the crankshaft 26 of the engine 22, the clutch C0 connecting and releasing both components.

Furthermore, the transmission 60 of the embodiment is a parallel shaft transmission including: a first transmission mechanism having the first-speed gear train and the third-speed gear train that are parallel shaft gear trains capable of connecting the carrier 45 as a first rotating element of the power distribution and integration mechanism 40 to the drive shaft 67; and a second transmission mechanism having the second-speed gear train and the fourth-speed gear train that are parallel shaft gear trains capable of connecting the first motor shaft 46 of the motor MG1 to the drive shaft 67. However, instead of the parallel shaft transmission 60, a planetary gear transmission may be employed in the hybrid vehicle 20 of the embodiment.

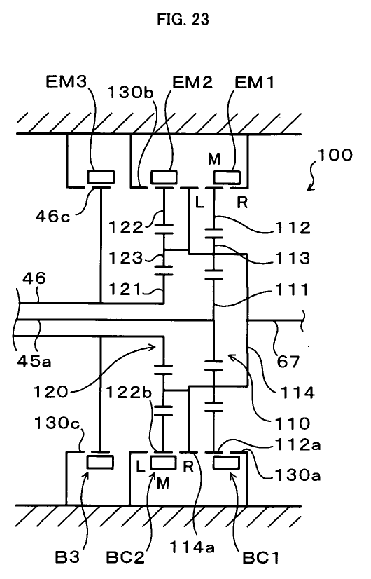

FIG. 23 is a schematic configuration diagram showing a planetary gear transmission 100 applicable to the hybrid vehicles 20 and 20A. The transmission 100 shown in FIG. 23 is also capable of setting the transmission state (transmission gear ratio) in a plurality of stages and includes, for example: a first transmission planetary gear mechanism 110 connected to the carrier 45, which is a first rotating element of the power distribution and integration mechanism 40, through the carrier shaft 45a; a second transmission planetary gear mechanism 120 that is connected to the first motor shaft 46 that can be connected to the sun gear 41, which is a second rotating element of the power distribution and integration mechanism 40 through the clutch C0; a brake clutch BC1 (first fixing unit and first fastening unit) as a connecting device of the present invention disposed with respect to the first transmission planetary gear mechanism 110; a brake, clutch BC2 (second fixing unit and second fastening unit) as a connecting device of the present invention disposed with respect to the second planetary gear mechanism 120; and a brake B3 (third fixing unit). The elements constituting the first transmission planetary gear mechanism 110, the second transmission planetary gear mechanism 120, the brake clutches BC1, BC2, and the brake B3 are all accommodated in the transmission case of the transmission 100.

As shown in FIG. 23, the first transmission planetary gear mechanism 110 is a single-pinion planetary gear mechanism having a sun gear 111 connected to the carrier shaft 45a, a ring gear 112 of the internal gear disposed concentrically with the sun gear 111, and a carrier 114 holding a plurality of pinion gears 113 meshed with both of the sun gear 111 and the ring gear 112 and connected to the drive shaft 67. The sun gear 111 (input element), the ring gear 112 (fixable element), and the carrier 114 (output element) are configured to be able to differentially rotate. The second transmission planetary gear mechanism 120 is a single pinion planetary gear mechanism having a sun gear 121 (input element) connected to the first motor shaft 46, a ring gear 122 (fixable element) of the internal gear disposed concentrically with the sun gear 121, and a carrier 114 (output element), which is shared by the first transmission planetary gear mechanism 110, holding a plurality of pinion gears 123 meshed with both of the sun gear 121 and the ring gear 122. The sun gear 121, the ring gear 122, and the carrier 114 are configured to be able to differentially rotate. In the embodiment, the second transmission planetary gear mechanism 120 is arranged coaxially, side by side with the first transmission planetary gear mechanism 110, and closer to the front of the car. The carrier shaft 45a is arranged so as to penetrate through the first motor shaft 46. The sun gear 111 of the first transmission planetary gear mechanism 110 is fixed to the tip of the carrier shaft 45a protruded from the first motor shaft 46.

The brake clutch BC1 is configured as a dog clutch including: the movable engaging member EM1 that is constantly meshed with an engaging portion 112a mounted on the periphery of a ring gear 112 of the first transmission planetary gear mechanism 110 and that is engageable to the locking portion 130a (fixed engaging element) fixed to the transmission case and engageable to the engaging portion 114a formed on the periphery of the carrier 114; and an electromagnetic, electric, or hydraulic actuator (not shown) that advances and retracts the movable engaging member EM1 in the axial direction of the carrier shaft 45a and the like. The engaging portion 112a and the locking portion 130a of the ring gear 112 and the engaging portion 114a of the carrier 114 are configured as external gear-shaped dogs having a plurality of dog teeth, the dog teeth being the same number and the same module. The movable engaging member EM1 is configured as an internal gear-shaped dog having a plurality of dog teeth DT, the dog teeth DT being the same number and the same module as the dog teeth of the engaging portion 112a, the locking portion 130a, and the engaging portion 114a. The movable engaging member EM1 has dimensions allowing simultaneous engagement with either the engaging portion 112a and the locking portion 130a of the ring gear 112 or the engaging portion 114a of the carrier 114. As shown in FIG. 23, the brake clutch BC1 can selectively switch the clutch position, which is the position of the movable engaging member EM1, to “R-position”, “M-position”, or “L-position”. If the clutch position of the brake clutch BC1 is set to the R-position, the movable engaging member EM1 engages with both of the engaging portion 112a of the ring gear 112 and the locking portion 130a fixed to the transmission case. This enables to nonrotatably fix the ring gear 112, which is a fixable element of the first transmission planetary gear mechanism 110, to the transmission case. If the clutch position of the brake clutch BC1 is set to the M-position, the movable engaging member EM1 engages only with the engaging portion 112a of the ring gear 112. This enables to release and make rotatable the ring gear 112 of the first transmission planetary gear mechanism 110. If the clutch position of the brake clutch BC1 is set to the L-position, the movable engaging member EM1 engages with both of the engaging portion 112a of the ring gear 112 and the engaging portion 114a of the carrier 114. This enables to fasten the ring gear 112, which is a fixable element of the first transmission planetary gear mechanism 110, and the carrier 114, which is an output element.

The brake clutch BC2 is configured as a dog clutch including: the movable engaging member EM2 that is constantly meshed with an engaging portion 122b formed on the periphery of a ring gear 122 of the second transmission planetary gear mechanism 120 and that is engageable to the locking portion 130b (fixed engaging element) fixed to the transmission case and the engaging portion 114a formed on the periphery of the carrier 114; and an electromagnetic, electric, or hydraulic actuator (not shown) that advances and retracts the movable engaging member EM2 in the axial direction of the first motor shaft 46 and the like. The engaging portion 122b and the locking portion 130b of the ring gear 122 are configured as external gear-shaped dogs having a plurality of dog teeth DT, the dog teeth DT being the same number and the same module as those of the engaging portion 114a of the carrier 114. The movable engaging member EM2 is configured as an internal gear-shaped dog having a plurality of dog teeth DT, the dog teeth DT being the same number and the same module as the dog teeth of the engaging portion 122b, the locking portion 130b, and the engaging portion 114a. The movable engaging member EM2 has dimensions allowing simultaneous engagement with either the engaging portion 122b and the locking portion 130b of the ring gear 122 or the engaging portion 114a of the carrier 114. As shown in FIG. 23, the brake clutch BC2 also can selectively switch the clutch position, which is the position of the movable engaging member EM2, to “R-position”, “IM-position”, or “L-position”. If the clutch position of the brake clutch BC2 is set to the L-position, the movable engaging member EM2 engages with both of the engaging portion 122b of the ring gear 122 and the locking portion 130b fixed to the transmission case. This enables to nonrotatably fix the ring gear 122, which is a fixable element of the second transmission planetary gear mechanism 120, to the transmission case. If the clutch position of the brake clutch BC2 is set to the M-position, the movable engaging member EM2 engages only with the engaging portion 122b of the ring gear 122. This enables to release and make rotatable the ring gear 122 of the second transmission planetary gear mechanism 120. If the clutch position of the brake clutch BC2 is set to the R-position, the movable engaging member EM2 engages with both of the engaging portion 122b of the ring gear 122 and the engaging portion 114a of the carrier 114. This enables to fasten the ring gear 122, which is a fixable element of the second transmission planetary gear mechanism 120, and the carrier 114, which is an output element.

The brake B3 is configured as a dog clutch including: a movable engaging member EM3 that is constantly engaged with an engaging portion 46c mounted on the edge (right-hand edge in FIG. 23) of the first motor shaft 46 and that is engageable to the locking portion 130c (fixed engaging element) fixed to the transmission case; and an electromagnetic, electric, or hydraulic actuator (not shown) that advances and retracts the movable engaging member EM3 in the axial direction of the first motor shaft 46 and the like. The engaging portion 46c and the locking portion 130c of the first motor shaft 46 are configured as external gear-shaped dogs having a plurality of dog teeth DT, the dog teeth DT being the same number and the same module. The movable engaging member EM3 is configured as an internal gear-shaped dog having a plurality of dog teeth DT, the dog teeth DT being the same number and the same module as the dog teeth of the engaging portion 46c and the locking portion 130c. If the brake B3 is turned on, the movable engaging member EM2 engages with both of the engaging portion 46c of the first motor shaft 46 and the locking portion 130c fixed to the transmission case. As a result, the sun gear 41 of the power distribution and integration mechanism 40 can be fixed nonrotatably to the transmission case if the first motor shaft 46, i.e. the clutch Co, is engaged. The power transmitted from the carrier 114 of the transmission 100 to the drive shaft 67 is outputted through a differential gear DF and eventually to the rear wheels RWa and RWb as drive wheels. The transmission 100 configured as described above can significantly reduce axial and radial dimensions as compared to, for example, a parallel shaft transmission. The first transmission planetary gear mechanism 110 and the second transmission planetary gear mechanism 120 can be arranged coaxially with and on the downstream of the engine 22, the motors MG1, MG2, the reduction gear mechanism 50, and the power distribution and integration mechanism 40. Therefore, the use of the transmission 100 enables to simplify the bearings and reduce the number of the bearings. In the embodiment, the gear ratio (the number of teeth of the sun gear 121/the number of teeth of the ring gear 122) of the second transmission planetary gear mechanism 120 is larger in some degree than the gear ratio (the number of teeth of the sun gear 111/the number of teeth of the ring gear 112) ρ1 of the first transmission planetary gear mechanism 110. However, the gear ratios ρ1 and ρ2 of the first and second transmission planetary gear mechanisms 110 and 120 can be set to arbitrary values.

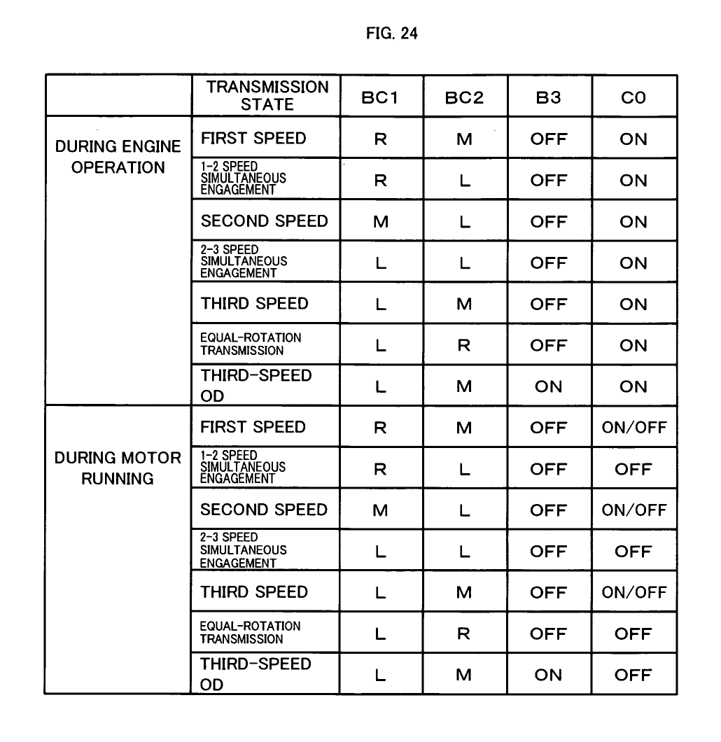

FIG. 24 illustrates setting conditions of the clutch positions and the like of the brake clutches BC1, BC2, the brake B3, and the clutch C0 during running of the hybrid vehicle having the transmission 100. As can be seen in FIG. 24, in the transmission 100, controlling of the actuators of the brake clutches BC1 and BC2 allows easy and smooth switching between the first transmission state (first speed) in which the first transmission planetary gear mechanism 110 shifts the power from the carrier 45 of the power distribution and integration mechanism 40 and transmits the power to the drive shaft 67, the second transmission state (second speed) in which the second transmission planetary gear mechanism 120 shifts the power from the sun gear 41 of the power distribution and integration mechanism 40 and transmits the power to the drive shaft 67, and the third transmission state (third speed) in which the first transmission planetary gear mechanism 110 transmits the power from the carrier 45 of the power distribution and integration mechanism 40 to the drive shaft 67 at a transmission gear ratio 1. Therefore, the transmission 100 allows selective and efficient transmission of power from the carrier 45 of the power distribution and integration mechanism 40 and power from the sun gear 41 to the drive shaft 67. An “equal-rotation transmission state” in the transmission 100 refers to a state in which the ring gear 112 and the carrier 114 of the first transmission planetary gear mechanism 110 are fastened and the ring gear 122 and the carrier 114 of the second transmission planetary gear mechanism 120 are fastened using the brake clutches BC1 and BC2. In the equal-rotation transmission state, the sun gear 41, the ring gear 42 (engine 22), and the carrier 45 of the power distribution and integration mechanism 40, the sun gear 111 and the ring gear 112 of the first transmission planetary gear mechanism 110, the sun gear 121 and the ring gear 122 of the second transmission planetary gear mechanism 120, and the carrier 114 shared by both components all rotate together. Therefore, the power from the engine 22 can be mechanically (directly) transmitted to the drive shaft 67 at a fixed transmission gear ratio (=1) in the equal-rotation transmission state. A “third-speed OD (over drive) state” in the transmission 100 refers to a state in which the brake B3 nonrotatably fixes the first motor shaft 46, i.e. the sun gear 41 as a second rotating element of the power distribution and integration mechanism 40, to the transmission case through the engaging portion 46c of the first motor shaft 46 in the third transmission state (third speed). In the third-speed OD state, the power from the engine 22 or the motor MG2 can be increased and mechanically (directly) transmitted to the drive shaft 67 at a fixed transmission gear ratio less than 1 (1/1−ρ), different from the 1-2 speed simultaneous engagement state, 2-3 speed simultaneous engagement state, and the equal-rotation transmission state. To realize the 1-2 speed simultaneous engagement state in the transmission 100, the motor MG1 is controlled in the first transmission state so that the rotation speed deviation of the rotation speed of the ring gear 122 as a fixable element of the second transmission planetary gear mechanism 120 from the value 0 (rotation speed of the locking portion 130b) matches a predetermined target rotation speed deviation, and the actuator of the brake clutch BC2 is controlled so that the movable engaging member EM2 moves toward the locking portion 130b for a predetermined time after the rotation speed deviation has matched the target rotation speed deviation. To realize the 2-3 speed simultaneous engagement state in the transmission 100, the motor MG2 is controlled in the second transmission state so that the rotation speed deviation of the rotation speed of the ring gear 112 as a fixable element of the first transmission planetary gear mechanism 110 from the rotation speed of the carrier 114 (rotation speed of the drive shaft 67) matches a predetermined target deviation, and the actuator of the brake clutch BC1 is controlled so that the movable engaging member EM1 moves toward the engaging portion 114a of the carrier 114 for a predetermined time after the rotation speed deviation has matched the target rotation speed deviation. To realize the equal-rotation transmission state in the transmission 100, the motor MG1 is controlled in the third transmission state so that the rotation speed deviation of the rotation speed of the ring gear 122 as a fixable element of the second transmission planetary gear mechanism 120 from the rotation speed of the carrier 114 (rotation speed of the drive shaft 67) matches a predetermined target deviation, and the actuator of the brake clutch BC2 is controlled so that the movable engaging member EM2 moves toward the engaging portion 114a of the carrier 114 for a predetermined time after the rotation speed deviation has matched the target rotation speed deviation. To realize the third-speed OD state in the transmission 100, the motor MG1 is controlled in the third transmission state so that the rotation speed deviation of the rotation speed of the engaging portion 46c of the first motor shaft 46 from the value 0 (rotation speed of the locking portion 130c) matches a predetermined target rotation speed deviation, and the actuator of the brake B3 is controlled so that the movable engaging member EM3 moves toward the locking portion 130c for a predetermined time after the rotation speed deviation has matched the target rotation speed deviation. The implementation of such a planetary gear transmission 100 also enables to obtain operational effects similar to the ones when the parallel shaft transmission 60 is used.

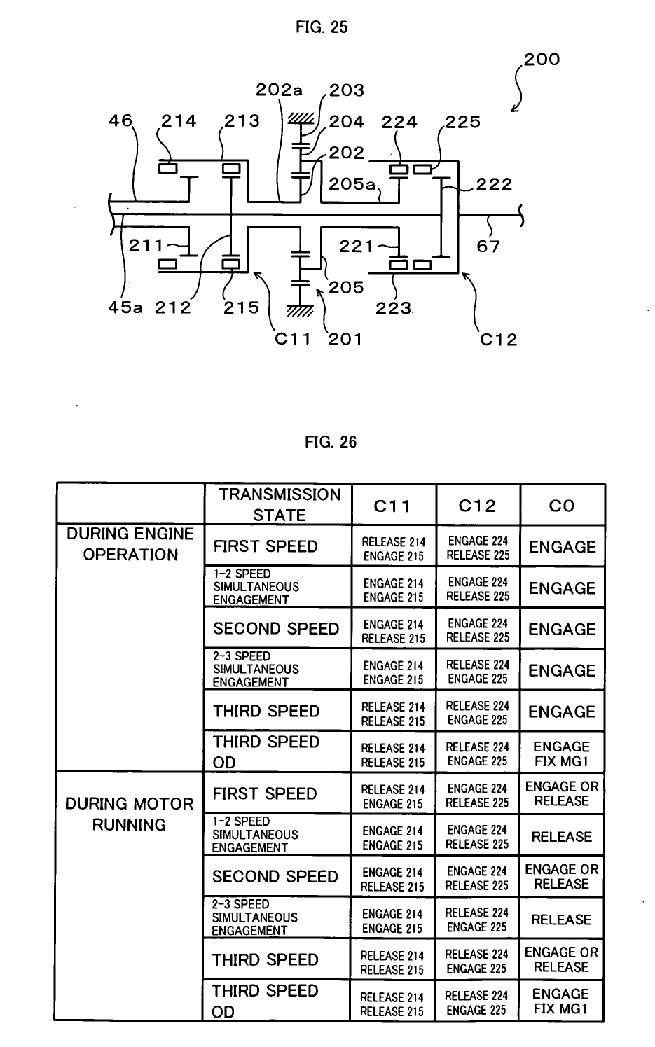

FIG. 25 is a schematic configuration diagram showing another planetary gear transmission 200 applicable to the hybrid vehicles 20 and 20A. The transmission 200 shown in FIG. 25 can also set the transmission state (transmission gear ratio) in a plurality of stages and includes a transmission differential rotation mechanism (deceleration unit) 201 and clutches C11 and C12. The transmission differential rotation mechanism 201 is a single-pinion planetary gear mechanism having a sun gear 202 that is an input element, a ring gear 203 as a fixed element nonrotatably fixed to the transmission case and disposed concentrically with the sun gear 202, and a carrier 205 as an output element holding a plurality of pinion gears 204 meshed with both of the sun gear 202 and the ring gear 203. The clutch C11 includes a first engaging portion 211 mounted on the tip of the first motor shaft 46, a second engaging portion 212 mounted on the carrier shaft 45a, a third engaging portion 213 mounted on a hollow sun gear shaft 202a connected to the sun gear 202 of the transmission differential rotation mechanism 201, a first movable engaging member 214 engageable to both of the first engaging portion 211 and the third engaging portion 213 and movable in the axial direction of the first motor shaft 46, the carrier shaft 45a, and the like, and a second movable engaging member 215 engageable to both of the second engaging portion 212 and the third engaging portion 213 and movable in the axial direction. The first engaging portion 211 of the first motor shaft 46 and the second engaging portion 212 of the carrier shaft 45a are configured as external gear-shaped dogs having a plurality of dog teeth DT, while the third engaging portion 213 of the sun gear shaft 202a is configured as an internal gear-shaped dog having a plurality of dog teeth DT. The first movable engaging member 214 is configured as a dog having a plurality of dog teeth DT on the inner periphery, the dog teeth DT being the same number and the same module as the dog teeth of the first engaging portion 211, and having a plurality of dog teeth DT on the periphery, the dog teeth DT being the same number and the same module as the dog teeth of the third engaging portion 213. The second movable engaging member 215 is configured as a dog having a plurality of dog teeth DT on the inner periphery, the dog teeth DT being the same number and the same module as the dog teeth of the second engaging portion 212, and having a plurality of dog teeth DT on the periphery, the dog teeth DT being the same number and the same module as the dog teeth of the third engaging portion 213. The first and second movable engaging members. 214 and 215 are driven by electromagnetic, electric, or hydraulic actuators (not shown). Suitable drive of the first movable engaging member 214 and the second movable engaging member 215 enables to selectively connect one or both of the first motor shaft 46 and the carrier shaft 45a to the sun gear 202 of the transmission differential rotation mechanism 201. The clutch C12 includes: a first engaging portion 221 mounted on the tip of a hollow carrier shaft 205a extending toward the back of the vehicle, the carrier shaft 205a connected to the carrier 205 as an output element of the transmission differential rotation mechanism 201; a second engaging portion 222 mounted on the carrier shaft 45a extending through the sun gear shaft 202a and the carrier shaft 205a; a third engaging portion 223 mounted on the drive shaft 67; a first movable engaging member 224 engageable to both of the first engaging portion 221 and the third engaging portion 223 and movable in the axial direction of the first motor shaft 46, the carrier shaft 45a, and the like; and a second movable engaging member 225 engageable to both of the second engaging portion 222 and the third engaging portion 223 and movable in the axial direction. The first engaging portion 221 of the carrier shaft 205a and the second engaging portion 222 of the carrier shaft 45a are configured as external gear-shaped dogs having a plurality of dog teeth DT, while the third engaging portion 223 of the drive shaft 67 is configured as an internal gear-shaped dog having a plurality of dog teeth DT. The first movable engaging member 224 is configured as a dog having a plurality of dog teeth DT on the inner periphery, the dog teeth DT being the same number and the same module as the dog teeth of the first engaging portion 221, and having a plurality of dog teeth DT on the periphery, the dog teeth DT being the same number and the same module as the dog teeth of the third engaging portion 223. The second movable engaging member 225 is configured as a dog having a plurality of dog teeth DT on the inner periphery, the dog teeth DT being the same number and the same module as the dog teeth of the second engaging portion 222, and having a plurality of dog teeth DT on the periphery, the dog teeth DT being the same number and the same module as the dog teeth of the third engaging portion 223. The first and second movable engaging members 224 and 225 are driven by electromagnetic, electric, or hydraulic actuators (not shown). Suitable drive of the first movable engaging member 224 and the second movable engaging member 225 enables to selectively connect one or both of the carrier shaft 205a and the carrier shaft 45a to the drive shaft 67. FIG. 26 shows operation states of the clutches C11, C12, and C0 during running of the hybrid vehicle having the transmission 200. The “third-speed OD (over drive) state” in the transmission 200 can be realized by the brake (not shown) fixing the first motor shaft 46 and the like in the third transmission state (third speed). Implementation of such a planetary gear transmission 200 also enables to obtain operational effects similar to the ones when the transmission 60 or the transmission 100 is used.

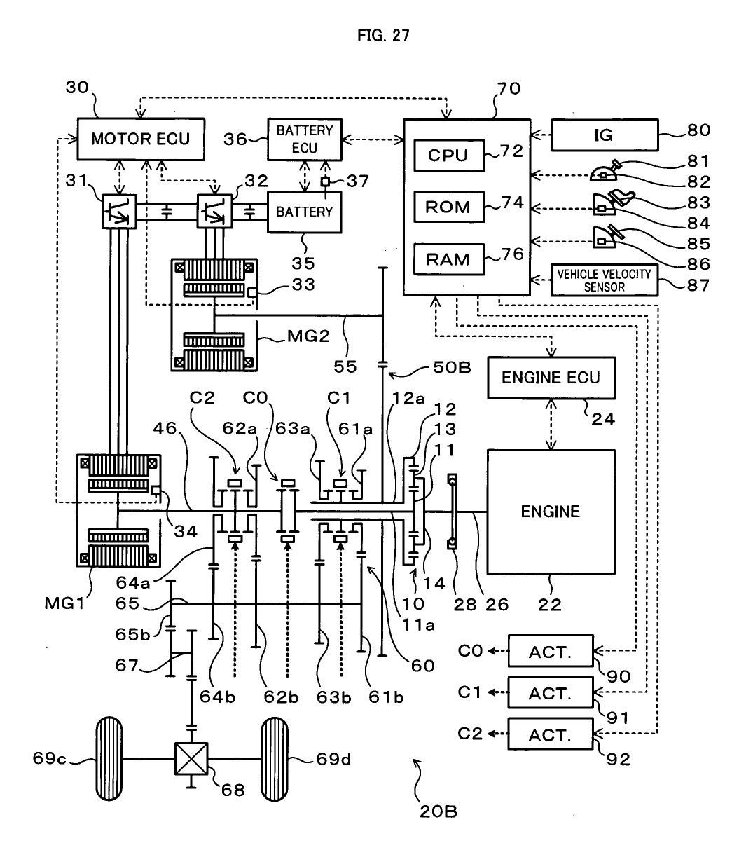

FIG. 27 is a schematic configuration diagram showing a hybrid vehicle 20B of a modified example. While the hybrid vehicles 20 and 20A are configured as rear wheel drive vehicles, the hybrid vehicle 20B of the modified example is configured as a front wheel drive vehicle that drives front wheels 69c and 69d. As shown in FIG. 27, the hybrid vehicle 20B is provided with a power distribution and integration mechanism 10 that is a single-pinion planetary gear mechanism including a sun gear 11, a ring gear 12 disposed concentrically with the sun gear 11, and a carrier 14 holding a plurality of pinion gears 13 meshed with both of the sun gear 11 and the ring gear 12. The engine 22 is placed transversely, and the crankshaft 26 of the engine 22 is connected to a carrier 14 that is a third rotating element of the power distribution and integration mechanism 10. A hollow ring gear shaft 12a is connected to the ring gear 12 as a first rotating element of the power distribution and integration mechanism 10, and the motor MG2 is connected to the ring gear shaft 12a through a reduction gear mechanism 50B, which is a parallel shaft gear train, and the second motor shaft 55 extending in parallel with the first motor shaft 46. The clutch C1 can selectively fix one of the first-speed gear train (gear 61a) and the third-speed gear train (gear 63a) constituting the first transmission mechanism of the transmission 60 to the ring gear shaft 12a. A sun gear shaft 11a is further connected to the sun gear 11 as a second rotating element of the power distribution and integration mechanism 10, and the sun gear shaft 11a is connected to the clutch C0 through the hollow ring gear shaft 12a. The clutch C0 can connect the sun gear shaft 11a to the first motor shaft 46, i.e., the motor MG1. One of the second-speed gear train (gear 62a) and the fourth-speed gear train (gear 64a) that constitute the second transmission mechanism of the transmission 60 can be selectively fixed to the first motor shaft 46 using the clutch C2. In this way, the hybrid vehicle of the present invention can be constituted as a front wheel drive vehicle.

It is obvious that the drive and control routines of FIGS. 15, 20, and 21 can be selectively used depending on the running conditions or the like. All of the hybrid vehicles 20, 20A, and 20B can be constituted as rear-wheel based or front-wheel based four-wheel-drive vehicles. The power output apparatuses are mounted on the hybrid vehicles 20, 20A, and 20B in the description of the embodiments and the modified examples. However, the power output apparatuses of the present invention may be mounted on movable bodies such as cars other than vehicles, ships, and airplanes, or may be incorporated into fixed equipment such as construction equipment.

Relationships between the primary elements of the embodiments and the modified examples and the primary elements of the invention described in the section of summary of the invention will be described herein. In the embodiments and the modified examples, the first to fourth gears 61a to 64a of the transmission 60, the locking portions 130a to 130c and the carrier 114 of the transmission 100, the sun gear shaft 202a and the drive shaft 67 of the transmission 200, and the like are equivalent to the “first element”. The motors MG1 and MG2 are equivalent to the “rotational drive source”, the carrier shaft 45a, the first motor shaft 46, the ring gears 112 and 122 of the transmission 100, and the like are equivalent to the “second element”. The clutches C0, C1, C2, C11, C12, the brake clutches BC1, BC2, the brake B3, and the like are equivalent to the “connecting device”. The engaging portions 61e to 64e of the transmission 60, the locking portions 130a to 130c and the engaging portion 114a of the transmission 100, and the third engaging portions 213 and 223 of the transmission 200 are equivalent to the “first engaging element”. The engaging portions 45e and 46e of the transmission 60, the engaging portions 112a and 122b of the transmission 100, and the engaging portions 211, 212, 221, and 222 of the transmission 200 are equivalent to the “second engaging element”. The movable engaging members EM1, EM2, EM3, 214, 215, 224, and 225 are equivalent to the “movable engaging member”. The actuators 91 and 92 are equivalent to the “drive unit”. The combination of the hybrid ECU 70 executing one of the drive and control routines of FIGS. 15, 20, and 21 and the motor ECU 30 controlling the motors MG1 and MG2 in accordance with instructions from the hybrid ECU 70 is equivalent to the “control unit”. The transmission 60 is equivalent to the “first transmission”. The transmission 100 is equivalent to the “second transmission”. The engine 22 is equivalent to the “internal combustion engine”. The motor MG2 capable of inputting and outputting power is equivalent to the “first motor”. The motor MG1 capable of inputting and outputting power is equivalent to the “second motor”. The battery 35 capable of exchanging electric power with the motors MG1 and MG2 is equivalent to the “accumulator unit”. The power distribution and integration mechanisms 40, 40A, and 10 are equivalent to the “power distribution and integration mechanism”.

However, the “control unit” may be in any other form, such as a single electronic control unit, as long as the unit controls the rotational drive source so that the deviation of the rotation speed of the second element from the rotation speed of the first element matches a predetermined target deviation and controls the drive unit so that the movable engaging element moves toward the other of the first and second engaging element for a predetermined time after the deviation has matched the target deviation, if the movable engaging element is to be engaged with both of the first and second engaging elements to connect the first element and the second element when the movable engaging element is engaged with only one of the first and second engaging elements. The “internal combustion engine” is not restricted to the engine 22 that outputs power after supplied with hydrocarbon fuel such as gasoline and light oil, but may be in any other form such as a hydrogen engine. The “first motor” and the “second motor” are not restricted to synchronous motor generators such as the motors MG1 and MG2, but may be in any other form such as an induction motor. The “accumulator unit” is not restricted to a secondary battery such as the battery 35, but may be in any other form such as a capacitor capable of exchanging electric power with the electric power-mechanical power input output mechanism or the electric motor. The “power distribution and integration mechanism” may be in any other form as long as the first rotating element connected to the rotating shaft of the first motor, the second rotating element connected to the rotating shaft of the second motor, and the third rotating element connected to the engine shaft of the internal combustion engine are included and the three rotating elements are designed to be able to differentially rotate. In any case, the relationships between the primary elements of the embodiments and the modified examples and the primary elements of the invention described in the section of summary of the invention do not limit the elements of the invention described in the section of summary of the invention, because the embodiments are examples of specific descriptions of the preferred embodiments of the present invention described in the section of summary of the invention. Therefore, the embodiments are only specific examples of the invention described in the section of the summary of the invention, and the invention described in the section of summary of the invention should be interpreted based on the description in the section.

The embodiment discussed above is to be considered in all aspects as illustrative and not restrictive. There may be many modifications, changes, and alterations without departing from the scope or spirit of the main characteristics of the present invention.

The disclosure of Japanese Patent Application No. 2007-145929 filed May 31, 2007 including specification, drawings and claims is incorporated herein by reference in its entirety.

What is claimed is:

1. A connecting device capable of connecting a first element and a second element rotated by a predetermined rotational drive source, the connecting device comprising:
a first engaging element mounted on the first element and having a plurality of teeth;
a second engaging element mounted on the second element spaced apart from the first engaging element and having a plurality of teeth;
a movable engaging element having a plurality of teeth that mesh with both of the plurality of teeth of the first engaging element and the plurality of teeth of the second engaging element and engageable to both of the first and second engaging elements;
a drive unit capable of advancing and retracting the movable engaging element; and
a control unit that controls the rotational drive source so that the deviation of the rotation speed of the second element from the rotation speed of the first element matches a predetermined target deviation if the movable engaging element is to be engaged with both of the first and second engaging elements to connect the first element and the second element when the movable engaging element is engaged with only one of the first and second engaging elements, and that controls the drive unit so that the movable engaging element moves toward the other of the first and second engaging elements for a predetermined time after the deviation has matched the target deviation.

2. A connecting device according to claim 1, wherein the target deviation is a predetermined value other than a value 0.

3. A connecting device according to claim 1, wherein the control unit changes the target deviation so that the sign of the deviation is inverted at least once after the deviation has matched the target deviation.

4. A connecting device according to claim 1, wherein the control unit periodically changes the target deviation at least after the deviation has matched the target deviation.

5. A connecting device according to claim 2, wherein
the control unit applies a feedback control to the rotational drive source so that the deviation matches the target deviation and inverts the sign of the target deviation when the deviation becomes substantially a value 0 after the deviation has temporarily matched the target deviation.

6. A connecting device according to claim 1, wherein
the control unit sets the target deviation to a value 0 and changes the target deviation for a predetermined amount after the deviation has matched the target deviation.

7. A connecting device according to claim 6, wherein
the predetermined amount is a value based on the tooth thickness and the backlash of the second engaging element.

8. A transmission capable of selectively transmitting power from a first rotational drive source and power from a second rotational drive source to an output shaft, the transmission comprising:
a first input shaft connected to the first rotational drive source;
a second input shaft connected to the second rotational drive source;
an engaging element mounted on the first input shaft and having a plurality of teeth;
an engaging element mounted on the second input shaft and having a plurality of teeth;
a first transmission mechanism including at least a set of parallel shaft gear train including a driving gear rotatable about an axis extending in parallel with the output shaft and a driven gear meshed with the driving gear and connected to the output shaft;
a second transmission mechanism including at least a set of parallel shaft gear train including a driving gear rotatable about an axis extending in parallel with the output shaft and a driven gear meshed with the driving gear and connected to the output shaft;
an engaging element mounted on the driving gear of the first transmission mechanism and having a plurality of teeth;
an engaging element mounted on the driving gear of the second transmission mechanism and having a plurality of teeth;
a first movable engaging element having a plurality of teeth meshed with both of the plurality of teeth of the engaging element mounted on the first input shaft and the plurality of teeth of the engaging element mounted on the driving gear of the first transmission mechanism and engageable to both engaging elements;
a first drive unit capable of advancing and retracting the first movable engaging element;
a second movable engaging element having a plurality of teeth meshed with both of the plurality of teeth of the engaging element mounted on the second input shaft and the plurality of teeth of the engaging element mounted on the driving gear of the second transmission mechanism and engageable to both engaging elements;
a second drive unit capable of advancing and retracting the second movable engaging element; and
a control unit that controls the first or second rotational drive source so that the deviation of the rotation speed of the first or second input shaft from the rotation speed of the driving gear of the first or second transmission mechanism matches a predetermined target deviation if the first or second movable engaging element is to be engaged with both of the two engaging elements corresponding to the first or second movable engaging element when the first or second movable engaging element is engaged with only one of the two engaging elements corresponding to the first or second movable engaging element, and that controls the first or second drive unit so that the first or second movable engaging element moves toward the other of the engaging elements corresponding to the first or second movable engaging element for a predetermined time after the deviation has matched the target deviation.

9. A transmission capable of selectively transmitting power from a first rotational drive source and power from a second rotational drive source to an output shaft, the transmission comprising:
a first input shaft connected to the first rotational drive source;
a second input shaft connected to the second rotational drive source;
a first transmission planetary gear mechanism including an input element connected to the first input shaft, an output element connected to the output shaft, and a fixable element;
a second transmission planetary gear mechanism including an input element connected to the second input shaft, an output element connected to the output shaft, and a fixable element;
an engaging element mounted on the fixable element of the first transmission planetary gear mechanism and having a plurality of teeth;
a nonrotatable fixed engaging element disposed with respect to the first transmission planetary gear mechanism and having a plurality of teeth;
an engaging element mounted on the fixable element of the second transmission planetary gear mechanism and having a plurality of teeth;
a nonrotatable fixed engaging element disposed with respect to the second transmission planetary gear mechanism and having a plurality of teeth;
a first movable engaging element having a plurality of teeth meshed with both of the plurality of teeth of the engaging element mounted on the fixable element of the first transmission planetary gear mechanism and the plurality of teeth of the fixed engaging element disposed with respect to the first transmission planetary gear mechanism and engageable to both of the engaging element and the fixed engaging element;
a first drive unit capable of advancing and retracting the first movable engaging element;
a second movable engaging element having a plurality of teeth meshed with both of the plurality of teeth of the engaging element mounted on the fixable element of the second transmission planetary gear mechanism and the plurality of teeth of the fixed engaging element disposed with respect to the second transmission planetary gear mechanism and engageable to both of the engaging element and the fixed engaging element;
a second drive unit capable of advancing and retracting the second movable engaging element;
a control unit that controls the first or second rotational drive source so that the deviation of the rotation speed of the fixable element included in the first or second transmission planetary gear mechanism from a value 0 matches a predetermined target deviation if the first or second movable engaging element is to be engaged with both of the engaging element and the fixed engaging element corresponding to the first or second movable engaging element when the first or second movable engaging element is engaged with only one of the engaging element and the fixed engaging element corresponding to the first or second movable engaging element, and that controls the first or second drive unit so that the first or second movable engaging element moves toward the other of the engaging element and the fixed engaging element corresponding to the first or second movable engaging element for a predetermined time after the deviation has matched the target deviation.

10. A transmission according to claim 9, further comprising
an engaging element mounted on an output element of one of the first and second transmission planetary gear mechanisms and having a plurality of teeth,
wherein the first or second movable engaging element corresponding to one of the first and second transmission planetary gear mechanisms is engageable to both of the fixable element of one of the first and second transmission planetary gear mechanisms and the engaging element mounted on the output element, and
wherein the control unit controls the first or second rotational drive source so that the deviation of the rotation speed of the fixable element from the rotation speed of the output element matches a predetermined target deviation if the first or second movable engaging element is to be engaged with the engaging elements of both of the fixable element and the output element corresponding to the first or second movable engaging element when the first or second movable engaging element corresponding to one of the first and second transmission planetary gear mechanisms is engaged with the engaging element of only one of the fixable element and the output element corresponding to one of the first and second transmission planetary gear mechanisms, and that controls the first or second drive unit so that the first or second movable engaging element moves toward the engaging portion of the other of the fixable element and the output element corresponding to the first or second movable engaging element for a predetermined time after the deviation has matched the target deviation.

11. A power output apparatus that outputs power to a drive shaft, the power output apparatus comprising:
an internal combustion engine;
a first motor capable of inputting and outputting power;
a second motor capable of inputting and outputting power;
an accumulator unit capable of inputting and outputting electric power from and to the first and second motors;
a power distribution and integration mechanism having a first rotating element connected to the rotating shaft of the first motor, a second rotating element connected to the rotating shaft of the second motor, and the third rotating element connected to the engine shaft of the internal combustion engine, the three rotating elements configured to be able to differentially rotate;
a first input shaft connected to the first rotating element of the power distribution and integration mechanism;
a second input shaft connected to the second rotating element of the power distribution and integration mechanism;
an engaging element mounted on the first input shaft and having a plurality of teeth;
an engaging element mounted on the second input shaft and having a plurality of teeth;
a first transmission mechanism including at least a set of parallel shaft gear train including a driving gear rotatable about an axis extending in parallel with the output shaft and a driven gear meshed with the driving gear and connected to the output shaft;
a second transmission mechanism including at least a set of parallel shaft gear train including a driving gear rotatable about an axis extending in parallel with the output shaft and a driven gear meshed with the driving gear and connected to the output shaft;
an engaging element mounted on the driving gear of the first transmission mechanism and having a plurality of teeth;
an engaging element mounted on the driving gear of the second transmission mechanism and having a plurality of teeth;
a first movable engaging element having a plurality of teeth meshed with both of the plurality of teeth of the engaging element mounted on the first input shaft and the plurality of teeth of the engaging element mounted on the driving gear of the first transmission mechanism and engageable to both engaging elements;
a first drive unit capable of advancing and retracting the first movable engaging element;
a second movable engaging element having a plurality of teeth meshed with both of the plurality of teeth of the engaging element mounted on the second input shaft and the plurality of teeth of the engaging element mounted on the driving gear of the second transmission mechanism and engageable to both engaging elements;
a second drive unit capable of advancing and retracting the second movable engaging element; and
a control unit that controls the first or second rotational drive source so that the deviation of the rotation speed of the first or second input shaft from the rotation speed of the driving gear of the first or second transmission mechanism matches a predetermined target deviation if the first or second movable engaging element is to be engaged with both of the two engaging elements corresponding to the first or second movable engaging element when the first or second movable engaging element is engaged with only one of the two engaging elements corresponding to the first or second movable engaging element, and that controls the first or second drive unit so that the first or second movable engaging element moves toward the other of the engaging elements corresponding to the first or second movable engaging element for a predetermined time after the deviation has matched the target deviation.

12. A power output apparatus that outputs power to a drive shaft, the power output apparatus comprising:
an internal combustion engine;
a first motor capable of inputting and outputting power;
a second motor capable of inputting and outputting power;
an accumulator unit capable of inputting and outputting electric power from and to the first and second motors;
a power distribution and integration mechanism having a first rotating element connected to the rotating shaft of the first motor, a second rotating element connected to the rotating shaft of the second motor, and the third rotating element connected to the engine shaft of the internal combustion engine, the three rotating elements configured to be able to differentially rotate;
a first input shaft connected to the first rotating element of the power distribution and integration mechanism;
a second input shaft connected to the second rotating element of the power distribution and integration mechanism;
a first input shaft connected to the first rotational drive source;
a second input shaft connected to the second rotational drive source;
a first transmission planetary gear mechanism including an input element connected to the first input shaft, an output element connected to the output shaft, and a fixable element;
a second transmission planetary gear mechanism including an input element connected to the second input shaft, an output element connected to the output shaft, and a fixable element;
an engaging element mounted on the fixable element of the first transmission planetary gear mechanism and having a plurality of teeth;
a nonrotatable fixed engaging element disposed with respect to the first transmission planetary gear mechanism and having a plurality of teeth;
an engaging element mounted on the fixable element of the second transmission planetary gear mechanism and having a plurality of teeth;
a nonrotatable fixed engaging element disposed with respect to the second transmission planetary gear mechanism and having a plurality of teeth;
a first movable engaging element having a plurality of teeth meshed with both of the plurality of teeth of the engaging element mounted on the fixable element of the first transmission planetary gear mechanism and the plurality of teeth of the fixed engaging element disposed with respect to the first transmission planetary gear mechanism and engageable to both of the engaging element and the fixed engaging element;
a first drive unit capable of advancing and retracting the first movable engaging element;
a second movable engaging element having a plurality of teeth meshed with both of the plurality of teeth of the engaging element mounted on the fixable element of the second transmission planetary gear mechanism and the plurality of teeth of the fixed engaging element disposed with respect to the second transmission planetary gear mechanism and engageable to both of the engaging element and the fixed engaging element;
a second drive unit capable of advancing and retracting the second movable engaging element;
a control unit that controls the first or second rotational drive source so that the deviation of the rotation speed of the fixable element included in the first or second transmission planetary gear mechanism from a value 0 matches a predetermined target deviation if the first or second movable engaging element is to be engaged with both of the engaging element and the fixed engaging element corresponding to the first or second movable engaging element when the first or second movable engaging element is engaged with only one of the engaging element and the fixed engaging element corresponding to the first or second movable engaging element, and that controls the first or second drive unit so that the first or second movable engaging element moves toward the other of the engaging element and the fixed engaging element corresponding to the first or second movable engaging element for a predetermined time after the deviation has matched the target deviation.

13. A method of controlling a connecting device that can connect a first element and a second element rotated by a predetermined rotational drive source, the connecting device including: a first engaging element mounted on the first element and having a plurality of teeth, a second engaging element mounted on the second element and having a plurality of teeth; a movable engaging element having a plurality of teeth meshed with both of the plurality of teeth of the first engaging element and the plurality of teeth of the second engaging element and engageable to both of the first and second engaging elements; and a drive unit capable of advancing and retracting the movable engaging element, the method of controlling the connecting device comprising:
(a) a step of controlling the rotational drive source so that the deviation of the rotation speed of the second element from the rotation speed of the first element matches a predetermined target deviation if the movable engaging element is to be engaged with both of the first and second engaging elements to connect the first element and the second element when the movable engaging element is engaged with only one of the first and second engaging elements; and
(b) a step of controlling the drive unit so that the movable engaging element moves toward the other of the first and second engaging element for a predetermined time after the deviation has matched the target deviation.

14. A method of controlling the connecting device according to claim 13, wherein
the target deviation is a predetermined value other than a value 0.

15. A method of controlling the connecting device according to claim 13, wherein
the step (b) changes the target deviation so that the sign of the deviation is inverted at least once after the deviation has matched the target deviation.

16. A method of controlling the connecting device according to claim 13, wherein
the step (b) periodically changes the target deviation at least after the deviation has matched the target deviation.

17. A method of controlling the connecting device according to claim 14, wherein
the step (a) applies a feedback control to the rotational drive source so that the deviation matches the target deviation, and
the step (b) inverts the sign of the target deviation when the deviation becomes substantially a value 0 after the deviation has temporarily matched the target deviation.

18. A method of controlling the connecting device according to claim 13, wherein
the target deviation is a value 0 in the step (a), and
the step (b) changes the target deviation for a predetermined amount after the deviation has matched the target deviation.

19. A method of controlling the connecting device according to claim 18, wherein
the predetermined amount is a value based on the tooth thickness and the backlash of the second engaging element.
